(19) United States
(12) Patent Application Publication
(10) Pub. No.: US 2025/0133520 A1
(43) Pub. Date: Apr. 24, 2025

(54) COMMUNICATION TIMING FOR SIDELINK RELAY BETWEEN GROUND UE AND AERIAL DEVICE

(71) Applicant: QUALCOMM Incorporated, San Diego, CA (US)

(72) Inventors: Chao WEI, Beijing (CN); Hui GUO, Beijing (CN); Qiaoyu LI, Beijing (CN); Kangqi LIU, San Diego, CA (US); Hao XU, Beijing (CN)

(21) Appl. No.: 18/681,399

(22) PCT Filed: Sep. 24, 2021
(86) PCT No.: PCT/CN2021/120157

§ 371 Date: Feb. 5, 2024

(51) Int. Cl. H04W 56/00; H04W 8/00; H04W 72/25; H04W 84/06; H04W 92/18

(52) U.S. Cl. CPC H04W 56/0045; H04W 8/005; H04W 72/25; H04W 84/06; H04W 92/18

(57) ABSTRACT

An aerial device receives a timing advance configuration from a base station for sidelink communication with one or more user equipments (UEs), the timing advance configuration indicating an initial timing advance for the sidelink communication with the one or more UEs. The aerial device transmits a discovery message from the aerial device to the one or more UEs at a transmission time based on the initial timing advance relative to a reference time of a sidelink synchronization reference.

### INTRODUCTION

The present disclosure relates generally to communication systems, and more particularly, to sidelink communication with an aerial device.

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. Some aspects of wireless communication may comprise direct communication between devices based on sidelink. There exists a need for further improvements in sidelink technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method of wireless communication at an aerial device is provided. The method includes receiving a timing advance configuration from a base station for sidelink communication with one or more user equipments (UEs), the timing advance configuration indicating an initial timing advance for the sidelink communication with the one or more UEs. The method includes transmitting a discovery message from the aerial device to the one or more UEs at a transmission time based on the initial timing advance relative to a reference time of a sidelink synchronization reference.

In another aspect of the disclosure, an apparatus for wireless communication at an aerial device is provided. The apparatus includes means for receiving a timing advance configuration from a base station for sidelink communication with one or more user equipments (UEs), the timing advance configuration indicating an initial timing advance for the sidelink communication with the one or more UEs; and means for transmitting a discovery message from the aerial device to the one or more UEs at a transmission time based on the initial timing advance relative to a reference time of a sidelink synchronization reference.

In another aspect of the disclosure, an apparatus for wireless communication at an aerial device is provided. The apparatus includes memory and at least one processor coupled to the memory, the memory and the at least one processor configured to receive a timing advance configuration from a base station for sidelink communication with one or more UEs, the timing advance configuration indicating an initial timing advance for the sidelink communication with the one or more UEs; and transmit a discovery message from the aerial device to the one or more UEs at a transmission time based on the initial timing advance relative to a reference time of a sidelink synchronization reference.

In another aspect of the disclosure, a computer-readable storage medium storing computer executable code is provided for wireless communication at an aerial device, the code when executed by a processor cause the processor receive a timing advance configuration from a base station for sidelink communication with one or more UEs, the timing advance configuration indicating an initial timing advance for the sidelink communication with the one or more UEs; and transmit a discovery message from the aerial device to the one or more UEs at a transmission time based on the initial timing advance relative to a reference time of a sidelink synchronization reference.

In an aspect of the disclosure, a method of wireless communication at a base station is provided. The method includes transmitting downlink communication for one or more UEs to an aerial device for relay over a sidelink; and transmitting, to the aerial device, an indication of a timing advance configuration for sidelink communication with the one or more UEs, the timing advance configuration indicating an initial timing advance for the sidelink communication.

In another aspect of the disclosure, an apparatus for wireless communication at a base station is provided. The apparatus includes means for transmitting downlink communication for one or more UEs to an aerial device for relay over a sidelink; and means for transmitting, to the aerial device, an indication of a timing advance configuration for sidelink communication with the one or more UEs, the timing advance configuration indicating an initial timing advance for the sidelink communication.

In another aspect of the disclosure, an apparatus for wireless communication at a base station is provided. The apparatus includes memory and at least one processor coupled to the memory, the memory and the at least one processor configured transmit downlink communication for one or more UEs to an aerial device for relay over a sidelink; and transmit, to the aerial device, an indication of a timing advance configuration for sidelink communication with the one or more UEs, the timing advance configuration indicating an initial timing advance for the sidelink communication.

In another aspect of the disclosure, a computer-readable storage medium storing computer executable code is provided for wireless communication at base station, the code when executed by a processor cause the processor to transmit downlink communication for one or more UEs to an aerial device for relay over a sidelink; and transmit, to the aerial device, an indication of a timing advance configuration for sidelink communication with the one or more UEs, the timing advance configuration indicating an initial timing advance for the sidelink communication.

In an aspect of the disclosure, a method of wireless communication at a UE is provided. The method includes transmitting sidelink transmissions to multiple aerial devices based on a common frame timing; and receiving relayed transmissions from the multiple aerial devices based on the common frame timing.

In another aspect of the disclosure, an apparatus for wireless communication at a UE is provided. The apparatus includes means for transmitting sidelink transmissions to multiple aerial devices based on a common frame timing; and receiving relayed transmissions from the multiple aerial devices based on the common frame timing.

In another aspect of the disclosure, an apparatus for wireless communication at a UE is provided. The apparatus includes memory and at least one processor coupled to the memory, the memory and the at least one processor configured to transmit sidelink transmissions to multiple aerial devices based on a common frame timing; and receive relayed transmissions from the multiple aerial devices based on the common frame timing.

In another aspect of the disclosure, a computer-readable storage medium storing computer executable code is provided for wireless communication at a UE, the code when executed by a processor cause the processor to transmit sidelink transmissions to multiple aerial devices based on a common frame timing; and receive relayed transmissions from the multiple aerial devices based on the common frame timing.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network, in accordance with various aspects of the present disclosure.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 illustrates example aspects of a sidelink slot structure, in accordance with various aspects of the present disclosure.

FIG. 4 is a diagram illustrating an example of a first device and a second device involved in wireless communication, in accordance with various aspects of the present disclosure.

FIG. 5 illustrates example aspects of an air-to-ground (ATG) communication system, in accordance with aspects presented herein.

FIGS. 6A and 6B illustrate example options of relayed communication between a UE and a network via an aerial relay device, in accordance with aspects presented herein.

FIG. 7 illustrates an example of a timing offset between a timing reference radio frame and a sidelink reference radio frame for sidelink communication.

FIG. 8 illustrates an example of a UE exchanging communication with a network via multiple aerial relay devices at different altitudes, in accordance with aspects presented herein.

FIG. 9 illustrates an example timing diagram showing a timing adjustment at aerial relay devices to compensate for a propagation delay between a UE and the aerial relay devices, in accordance with aspects presented herein.

FIG. 10 illustrates an example timing diagram showing a timing adjustment at aerial relay devices to compensate for a propagation delay between a UE and the aerial relay devices, in accordance with aspects presented herein.

FIGS. 11A, 11B, and 11C illustrate examples of collisions between overlapping sidelink communication, in accordance with aspects presented herein.

FIG. 12 is a communication flow including relay of communication between a UE and a network at an aerial relay that applies a timing adjustment for the sidelink communication, in accordance with aspects presented herein.

FIGS. 13A and 13B are flowcharts of methods of wireless communication at an aerial relay, in accordance with aspects presented herein.

FIG. 14 is a diagram illustrating an example of a hardware implementation for an example apparatus, in accordance with aspects presented herein.

FIG. 15 is a flowchart of a method of wireless communication at a base station, in accordance with aspects presented herein.

FIG. 16 is a diagram illustrating an example of a hardware implementation for an example apparatus, in accordance with aspects presented herein.

FIG. 17 is a flowchart of a method of wireless communication at a UE, in accordance with aspects presented herein.

FIG. 18 is a diagram illustrating an example of a hardware implementation for an example apparatus, in accordance with aspects presented herein.

FIG. 19 illustrates an example diagram showing relayed communication between a base station and a UE via an aerial relay, in accordance with aspects presented herein.

### DETAILED DESCRIPTION

To enable the transmission of communication from a mobile device (e.g., a mobile UE) at a location without terrestrial cellular coverage, a number of approaches may be utilized. The communication may include any of various types of communication. In some aspects, the communication may include an emergency message (e.g., an SOS message), a text message, a voice call, or other communication. In some aspects, an aerial relay device may relay downlink/uplink communication between a ground-based base station and a UE using sidelink communication between the UE and the aerial device. The aerial device may receive communication from the ground-based base station for the UE and may transmit the communication to the UE in a sidelink transmission. In some aspects, a UE may transmit and/or receive communication with multiple aerial relays simultaneously, e.g., with transmission or reception with different aerial relays that overlaps at least partially in time. The communication with more than one aerial relay may provide for more reliable relayed communications. A UE may synchronize with the aerial relays by maintaining a separate timing tracking loop for each aerial relay. Then, the UE may adjust transmission and reception with each aerial relay based on a relative timing for the respective aerial relay. Aircraft may travel at different altitudes, leading to different propagation delays and different transmission and reception timing. Due to the different timing, in some aspects the UE may transmit or receive with a single aerial relay at a time, and may switch between different transmission and reception timing when switching between communication with different aerial relays. Aspects presented herein provide for more reliable relayed communication between a UE and a network via aerial relay by enabling the UE to transmit and receive with multiple aerial relay devices and enables simultaneous communication with various aerial relays without adjustment of the transmission and reception timing at the UE. Aspects presented herein provide power saving and improved reliability by enabling a UE to overlapping communication via multiple aerial relays. As an example, an emergency message from a ground UE can be received simultaneously by multiple aerial relays at different altitudes. As presented herein, the aerial relays may adjust transmission and reception timing with one or more UEs based on an altitude of the aerial relay. This allows the UEs to communicate with the aerial relay without synchronization at the UE to the different aerial relays. The UE power consumption may be reduced by enabling communication without prior synchronization of the UE with the aerial relay. As each aerial relay adjusts its timing based on its altitude, the UE may communicate with more than one aerial relay without adjusting timing at the UE. The transmission or reception of the same message via multiple aerial relay devices improves the reliability of communication for the UE.

The aspects presented herein include the adjustment of the transmission or reception timing of an aerial relay to synchronize with a ground UE based on an initial timing advance, and potentially a further timing advance update, which enables the ground UE to synchronize with a sidelink synchronization reference source such as a GNSS or a single aerial relay device, rather than individually synchronizing with each of multiple aerial relay devices.

As presented herein, an aerial relay device may adjust sidelink transmission timing and sidelink reception timing with one or more UEs based on an altitude dependent timing advance offset. As described herein, the timing advance offset may include a timing adjustment for transmission and/or reception to account for a propagation delay between the aerial relay device and the UE based on an altitude of the aerial relay. As the altitude of the aerial relay device will lead to a similar propagation delay for ground-based UEs, the aerial relay device may apply the altitude dependent timing advance offset as an initial timing advance offset in common for multiple UEs on the ground. As the propagation delay is based on the altitude of the aerial device, e.g., a height above the ground, the propagation delay will be similar for each UE at a ground level. The aerial relay device may advance sidelink transmission by the timing advance offset so that sidelink transmissions arrive at the UE in alignment with a reference synchronization source. Similarly, the aerial relay device may monitor for sidelink transmissions from one or more UEs at a reception time that is offset from the reference time based at least on the altitude dependent timing advance offset so that the UE may transmit the sidelink communication based on alignment with the reference synchronization source. The adjustment of the sidelink transmission and/or reception timing at the aerial relay device, which may be applied in common for one or more UEs, allows the UE to transmit and receive the sidelink communication based on the reference timing. As noted above, the reference timing may be based on a reference source, such as a GNSS timing, a base station timing, or a timing of a particular aerial relay device. The UE may use the same transmission and reception timing for communicating with multiple aerial relay devices. The aerial relay devices may each adjust their sidelink transmission timing and sidelink reception timing based on a current altitude. In some aspects, the aerial relay device may further adjust sidelink transmission timing and sidelink reception timing based on an uplink timing advance for communications with base station. In some aspects, the aerial relay device may adjust the transmission or reception frame timing for the sidelink communication with one or more UEs to account for a change in a propagation delay between the aerial relay and the UE (e.g. due to the movement of the aerial relay). The sidelink transmission frame timing may have an offset relative to the sidelink reception frame timing at the aerial relay device.

The aerial relay device may further handle collisions between time resources for sidelink transmission and sidelink reception by prioritizing one of the overlapping sidelink channels and skipping transmission or reception of another of the overlapping sidelink channels. By providing mechanisms for handling collisions, the UE, aerial relay device, and ground-based base station may more accurately anticipate the communication that may be prioritized or skipped, which may lead to more reliable communication. For example, if a UE is aware that an aerial device may skip feedback that overlaps with another channel or transmission, the UE may not interpret the absence of such feedback to indicate that the aerial device did not receive a transmission from the UE.

Although aspects are described in connection with relays mounted to or traveling with aircraft or other aerial vehicles, a sidelink relay may provide UE-to-UE relay in non-vehicle mounted applications, in some aspects.

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects and implementations are described in this application by illustration to some examples, those skilled in the art will understand that additional implementations and use cases may come about in many different arrangements and scenarios. Aspects described herein may be implemented across many differing platform types, devices, systems, shapes, sizes, and packaging arrangements. For example, implementations and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described aspects may occur. Implementations may range a spectrum from chip-level or modular components to non-modular, non-chip-level implementations and further to aggregate, distributed, or original equipment manufacturer (OEM) devices or systems incorporating one or more aspects of the described aspects. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that aspects described herein may be practiced in a wide variety of devices, chip-level components, systems, distributed arrangements, end-user devices, etc. of varying sizes, shapes, and constitution.

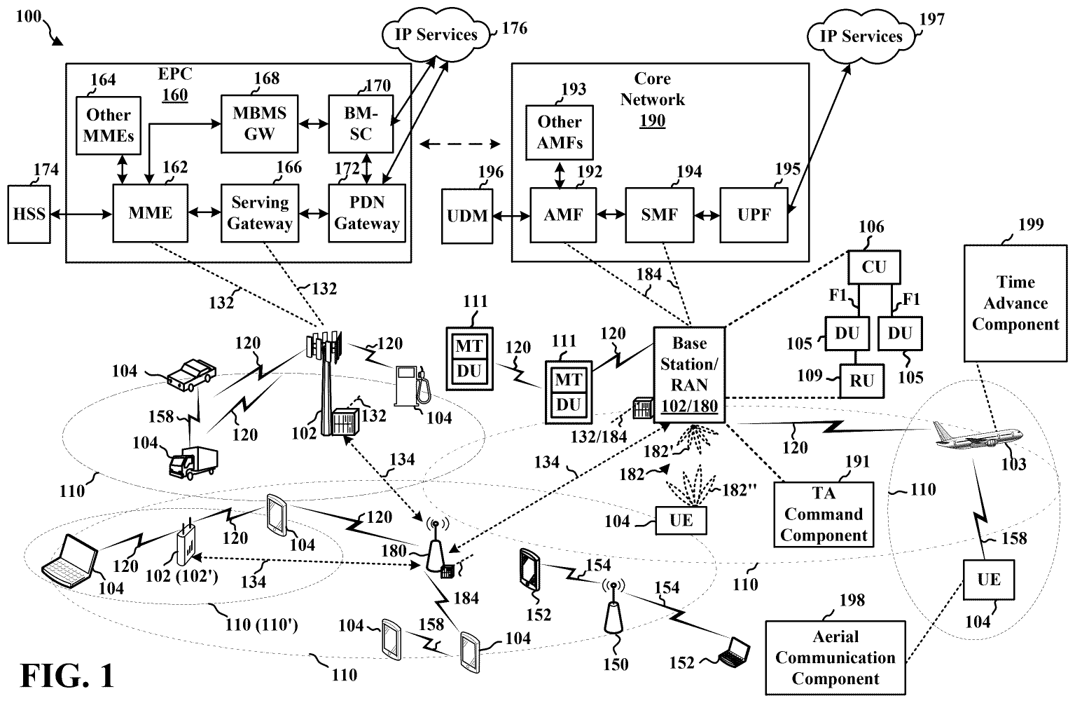

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

A link between a UE 104 and a base station 102 or 180 may be established as an access link, e.g., using a Uu interface. Other communication may be exchanged between wireless devices based on sidelink. For example, some UEs 104 may communicate with each other directly using a device-to-device (D2D) communication link 158. In some examples, the D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

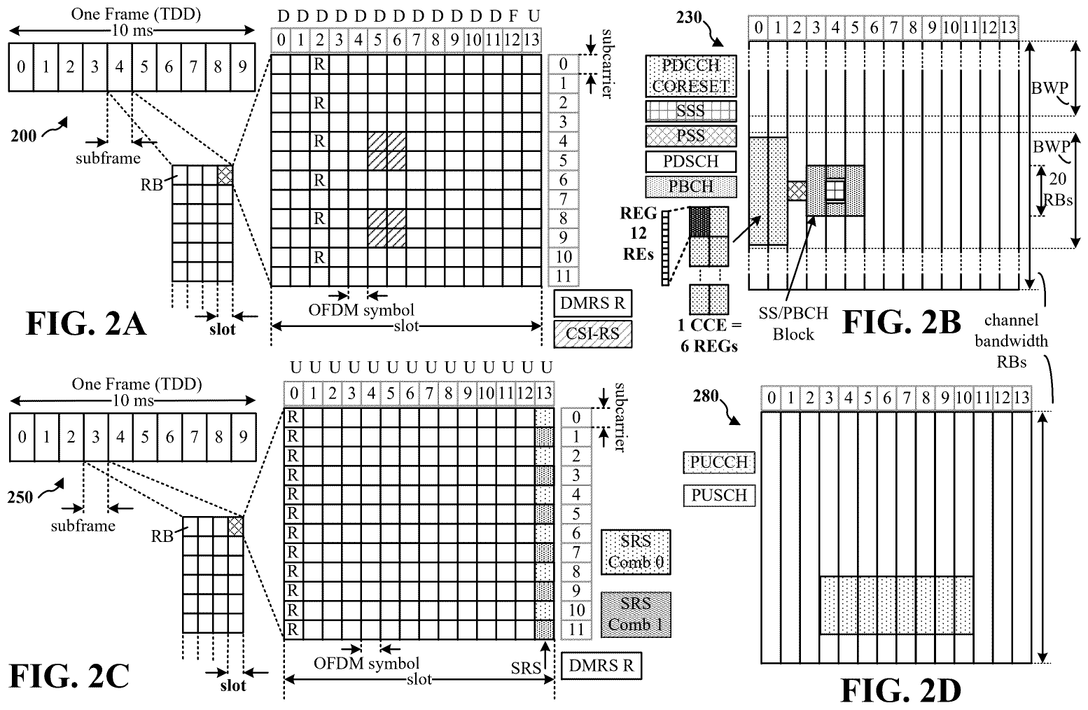

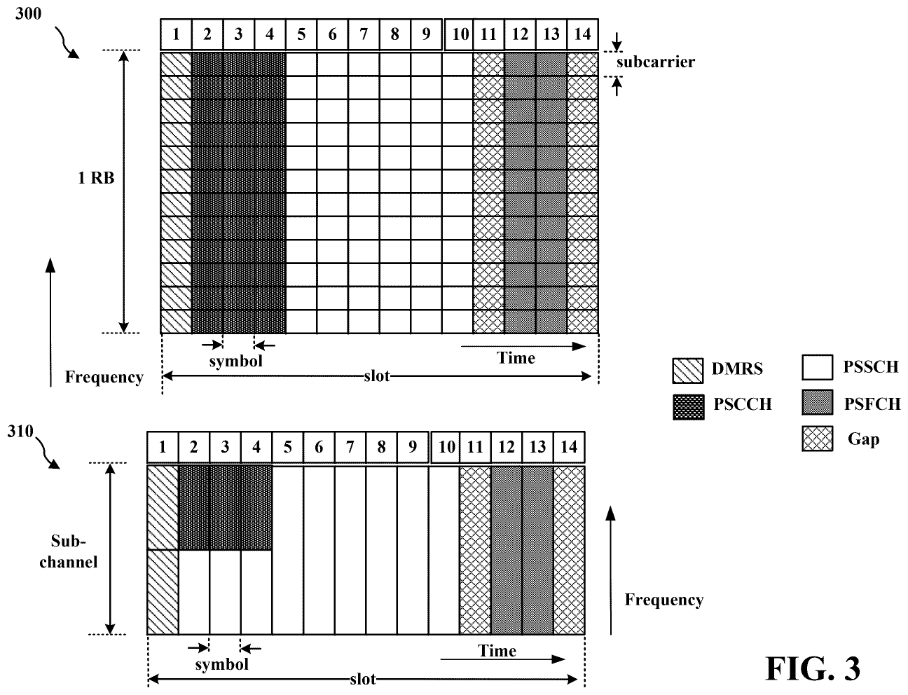

Some examples of sidelink communication may include vehicle-based communication devices that can communicate from vehicle-to-vehicle (V2V), vehicle-to-infrastructure (V2I) (e.g., from the vehicle-based communication device to road infrastructure nodes such as a Road Side Unit (RSU)), vehicle-to-network (V2N) (e.g., from the vehicle-based communication device to one or more network nodes, such as a base station), vehicle-to-pedestrian (V2P), cellular vehicle-to-everything (C-V2X), and/or a combination thereof and/or with other devices, which can be collectively referred to as vehicle-to-anything (V2X) communications. Sidelink communication may be based on V2X or other D2D communication, such as Proximity Services (ProSe), etc. In addition to UEs, sidelink communication may also be transmitted and received by other transmitting and receiving devices, such as Road Side Unit (RSU) 107, etc. Sidelink communication may be exchanged using a PC5 interface, such as described in connection with the example in FIG. 3. Although the following description, including the example slot structure of FIG. 2, may provide examples for sidelink communication in connection with 5G NR, the concepts described herein may be applicable to other similar areas, such as LTE, LTE-A, CDMA, GSM, and other wireless technologies.

Referring again to FIG. 1, in certain aspects, an aerial device (e.g., aerial relay 103) may include a time advance component 199 configured to receive, from a base station 102 or 180, a timing advance configuration from a base station for sidelink communications to one or more UEs 104, the timing advance configuration indicating an initial timing advance for the sidelink communications. The time advance component 199 may be further configured to transmit a discovery message from the aerial relay to the one or more UEs 104 at a transmission time based on the initial timing advance relative to a reference time of a sidelink synchronization reference. In some aspects, the UE 104 may include an aerial communication component 198 configured to transmit sidelink transmissions to multiple aerial relays 103 based on a common frame timing and/or to receive relayed transmissions from the multiple aerial relays 103 based on the common frame timing. In some aspects, a base station 102 or 180 may include a timing advance (TA) command component 191 configured to transmit, to the aerial relay, an indication of a timing advance configuration for a sidelink communications to the one or more UEs 104, the timing advance configuration indicating an initial timing advance for the sidelink communications. The aerial relay 103 may then apply the timing advance configuration indicated by the base station 102 or 180.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184 (e.g., Xn interface), and the third backhaul links 134 may be wired or wireless.

In some aspects, a base station 102 or 180 may be referred as a RAN and may include aggregated or disaggregated components. As an example of a disaggregated RAN, a base station may include a central unit (CU) 106, one or more distributed units (DU) 105, and/or one or more remote units (RU) 109, as illustrated in FIG. 1. A RAN may be disaggregated with a split between an RU 109 and an aggregated CU/DU. A RAN may be disaggregated with a split between the CU 106, the DU 105, and the RU 109. A RAN may be disaggregated with a split between the CU 106 and an aggregated DU/RU. The CU 106 and the one or more DUs 105 may be connected via an F1 interface. A DU 105 and an RU 109 may be connected via a fronthaul interface. A connection between the CU 106 and a DU 105 may be referred to as a midhaul, and a connection between a DU 105 and an RU 109 may be referred to as a fronthaul. The connection between the CU 106 and the core network may be referred to as the backhaul. The RAN may be based on a functional split between various components of the RAN, e.g., between the CU 106, the DU 105, or the RU 109. The CU may be configured to perform one or more aspects of a wireless communication protocol, e.g., handling one or more layers of a protocol stack, and the DU(s) may be configured to handle other aspects of the wireless communication protocol, e.g., other layers of the protocol stack. In different implementations, the split between the layers handled by the CU and the layers handled by the DU may occur at different layers of a protocol stack. As one, non-limiting example, a DU 105 may provide a logical node to host a radio link control (RLC) layer, a medium access control (MAC) layer, and at least a portion of a physical (PHY) layer based on the functional split. An RU may provide a logical node configured to host at least a portion of the PHY layer and radio frequency (RF) processing. A CU 106 may host higher layer functions, e.g., above the RLC layer, such as a service data adaptation protocol (SDAP) layer, a packet data convergence protocol (PDCP) layer. In other implementations, the split between the layer functions provided by the CU, DU, or RU may be different.

An access network may include one or more integrated access and backhaul (IAB) nodes 111 that exchange wireless communication with a UE 104 or other IAB node 111 to provide access and backhaul to a core network. In an IAB network of multiple IAB nodes, an anchor node may be referred to as an IAB donor. The IAB donor may be a base station 102 or 180 that provides access to a core network 190 or EPC 160 and/or control to one or more IAB nodes 111. The IAB donor may include a CU 106 and a DU 105. IAB nodes 111 may include a DU 105 and a mobile termination (MT). The DU 105 of an IAB node 111 may operate as a parent node, and the MT may operate as a child node.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

The wireless communications system may further include a Wi-Fi access point (AP) 150 in communication with Wi-Fi stations (STAs) 152 via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHZ, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming. Similarly, beamforming may be applied for sidelink communication, e.g., between UEs.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same. Although this example is described for the base station 180 and UE 104, the aspects may be similarly applied between a first and second device (e.g., a first and second UE) for sidelink communication.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme. As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

FIG. 3 includes diagrams 300 and 310 illustrating example aspects of slot structures that may be used for sidelink communication (e.g., between UEs 104, RSU 107, etc.). The slot structure may be within a 5G/NR frame structure in some examples. In other examples, the slot structure may be within an LTE frame structure. Although the following description may be focused on 5G NR, the concepts described herein may be applicable to other similar areas, such as LTE, LTE-A, CDMA, GSM, and other wireless technologies. The example slot structure in FIG. 3 is merely one example, and other sidelink communication may have a different frame structure and/or different channels for sidelink communication. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. Diagram 300 illustrates a single resource block of a single slot transmission, e.g., which may correspond to a 0.5 ms transmission time interval (TTI). A physical sidelink control channel may be configured to occupy multiple physical resource blocks (PRBs), e.g., 10, 12, 15, 20, or 25 PRBs. The PSCCH may be limited to a single sub-channel. A PSCCH duration may be configured to be 2 symbols or 3 symbols, for example. A sub-channel may comprise 10, 15, 20, 25, 50, 75, or 100 PRBs, for example. The resources for a sidelink transmission may be selected from a resource pool including one or more subchannels. As a non-limiting example, the resource pool may include between 1-27 subchannels. A PSCCH size may be established for a resource pool, e.g., as between 10-100% of one subchannel for a duration of 2 symbols or 3 symbols. The diagram 310 in FIG. 3 illustrates an example in which the PSCCH occupies about 50% of a subchannel, as one example to illustrate the concept of PSCCH occupying a portion of a subchannel. The physical sidelink shared channel (PSSCH) occupies at least one subchannel. The PSCCH may include a first portion of sidelink control information (SCI), and the PSSCH may include a second portion of SCI in some examples. Diagrams 300 and 310 illustrate PSCCH and PSSCH in a same slot. The PSCCH may be transmitted in an earlier part of the slot than the PSSCH. A first symbol may be repeated, e.g., for automatic gain control (AGC) settling.

A resource grid may be used to represent the frame structure. Each time slot may include a resource block (RB) (also referred to as physical RBs (PRBs)) that extends 12 consecutive subcarriers. The resource grid is divided into multiple resource elements (REs). The number of bits carried by each RE depends on the modulation scheme. As illustrated in FIG. 3, some of the REs may include control information in PSCCH and some REs may include demodulation RS (DMRS). At least one symbol may be used for feedback. FIG. 3 illustrates examples with two symbols for a physical sidelink feedback channel (PSFCH) with adjacent gap symbols. A symbol prior to and/or after the feedback may be used for turnaround between reception of data and transmission of the feedback. The gap enables a device to switch from operating as a transmitting device to prepare to operate as a receiving device, e.g., in the following slot. In other aspects, a slot may include PSCCH and PSSCH resources without resources for PSFCH, and a gap symbol may be provided after a last symbol of PSSCH. Data may be transmitted in the remaining REs, as illustrated. The data may comprise the data message described herein. The position of any of the data, DMRS, SCI, feedback, gap symbols, and/or LBT symbols may be different than the example illustrated in FIG. 3. Multiple slots may be aggregated together in some aspects.

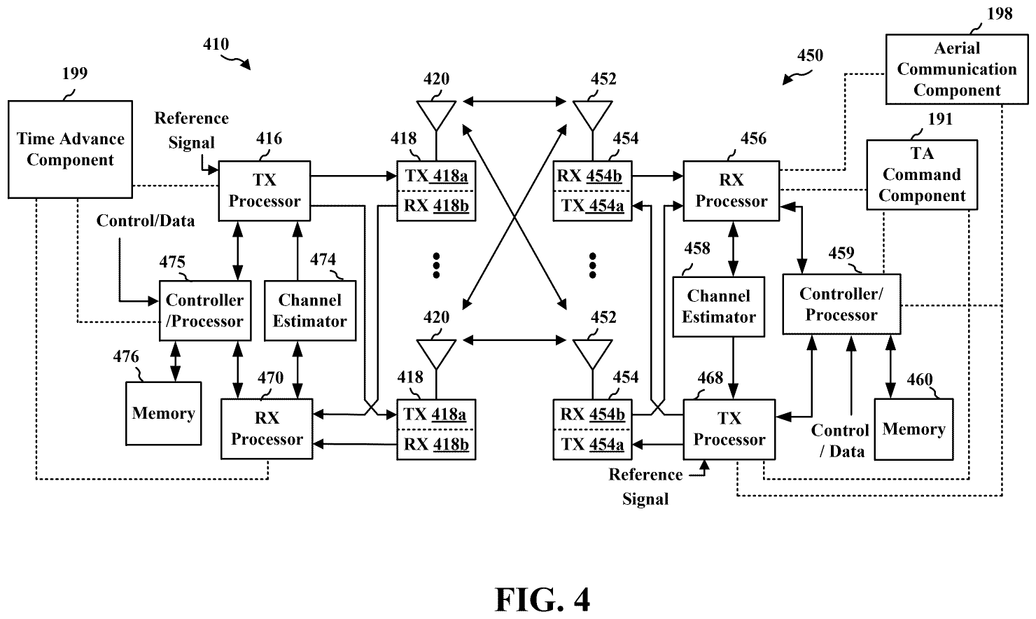

FIG. 4 is a block diagram of a first wireless communication device 410 in communication with a second wireless communication device 450 based on sidelink. In some examples, the devices 410 and 450 may communicate based on sidelink communication. In some aspects, the communication may be based on a PC5 interface. In other aspects, the communication may be based on an access link, e.g., based on a Uu interface. In some examples, the device 410 may correspond to an aerial relay 103 which may support communication with a base station with an access link and a UE with sidelink. Thus, in some examples, the device 450 may correspond to a UE 104, and in other examples, the device 450 may correspond to a base station. In examples in which the device 410 corresponds to an aerial relay 103, at least one of the TX processor 416, the RX processor 470, and the controller/processor 475 may be configured to perform aspects in connection with the time advance component 199 of FIG. 1. In aspects in which the device 450 corresponds to a UE 104, at least one of the TX processor 468, the RX processor 456, and the controller/processor 459 may be configured to perform aspects in connection with the aerial communication component 198 of FIG. 1. In aspects in which the device 450 corresponds to a base station 102 or 180, at least one of the TX processor 468, the RX processor 456, and the controller/processor 459 may be configured to perform aspects in connection with the TA command component 191 of FIG. 1.

Packets may be provided to a controller/processor 475 that implements layer 3 and layer 2 functionality. Layer 3 includes a radio resource control (RRC) layer, and layer 2 includes a packet data convergence protocol (PDCP) layer, a radio link control (RLC) layer, and a medium access control (MAC) layer.

The transmit (TX) processor 416 and the receive (RX) processor 470 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 416 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 474 may be used to determine the coding and modulation scheme, as well as for spatial processing. The channel estimate may be derived from a reference signal and/or channel condition feedback transmitted by the device 450. Each spatial stream may then be provided to a different antenna 420 via a separate transmitter 418a. Each transmitter 418a may modulate an RF carrier with a respective spatial stream for transmission.

At the device 450, each receiver 454b receives a signal through its respective antenna 452. Each receiver 454b recovers information modulated onto an RF carrier and provides the information to the receive (RX) processor 456. The TX processor 468 and the RX processor 456 implement layer 1 functionality associated with various signal processing functions. The RX processor 456 may perform spatial processing on the information to recover any spatial streams destined for the device 450. If multiple spatial streams are destined for the device 450, they may be combined by the RX processor 456 into a single OFDM symbol stream. The RX processor 456 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by device 410. These soft decisions may be based on channel estimates computed by the channel estimator 458. The soft decisions are then decoded and deinterleaved to recover the data and control signals that were originally transmitted by device 410 on the physical channel. The data and control signals are then provided to the controller/processor 459, which implements layer 3 and layer 2 functionality.

The controller/processor 459 can be associated with a memory 460 that stores program codes and data. The memory 460 may be referred to as a computer-readable medium. The controller/processor 459 may provide demultiplexing between transport and logical channels, packet reassembly, deciphering, header decompression, and control signal processing. The controller/processor 459 is also responsible for error detection using an ACK and/or NACK protocol to support HARQ operations.

Similar to the functionality described in connection with the transmission by device 410, the controller/processor 459 may provide RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 458 from a reference signal or feedback transmitted by device 410 may be used by the TX processor 468 to select the appropriate coding and modulation schemes, and to facilitate spatial processing. The spatial streams generated by the TX processor 468 may be provided to different antenna 452 via separate transmitters 454a. Each transmitter 454a may modulate an RF carrier with a respective spatial stream for transmission.

The transmission is processed at the device 410 in a manner similar to that described in connection with the receiver function at the device 450. Each receiver 418b receives a signal through its respective antenna 420. Each receiver 418b recovers information modulated onto an RF carrier and provides the information to a RX processor 470.

The controller/processor 475 can be associated with a memory 476 that stores program codes and data. The memory 476 may be referred to as a computer-readable medium. The controller/processor 475 provides demultiplexing between transport and logical channels, packet reassembly, deciphering, header decompression, control signal processing. The controller/processor 475 is also responsible for error detection using an ACK and/or NACK protocol to support HARQ operations.

To enable the transmission of communication from a mobile device (e.g., a mobile UE) at a location without terrestrial cellular coverage, a number of approaches may be utilized. The communication may include any of various types of communication. In some aspects, the communication may include an emergency message (e.g., an SOS message), a text message, a voice call, or other communication. In one approach, the communication may be transmitted and delivered via a satellite communication (SatCom) system such as the Iridium system or another similar system. This approach may leverage the existing satellites that are already in operation, and may be associated with fast implementation and low deployment costs. However, there may be limited satellite coverage, and the communication may involve a specific satellite UE to transmit and receive communication with the satellite. However, this approach may also be associated with strict antenna and TX power specifications. The operations may be human-assisted, where a skilled human may point the antenna toward the satellite to avoid blockage. Further, the approach may not be applicable to modern mobile devices with smaller form factors.

In another approach, the communication may be exchanged via a satellite-based non-terrestrial network (NTN), such as a 3GPP NTN. A satellite-based NTN may overcome some of the limitations associated with the SatCom system as described above. However, such NTNs may be associated with a high deployment cost to launch new satellites and install new gateways.

In another approach, the communication may be exchanged between a UE and a network via an aerial relay device. In some aspects, the aerial relay device may be provided at an aircraft. In some aspects, an aerial relay device may be provided via commercial aircraft to provide extended coverage for an area without a terrestrial base station. The air traffic provided by such aircraft may provide dense coverage, e.g., with aircraft within 50 km of each other. A typical cruising altitude may be on a scale of 10 kilometers (km) and may allow for line of sight (LOS) propagation for over 200 km.

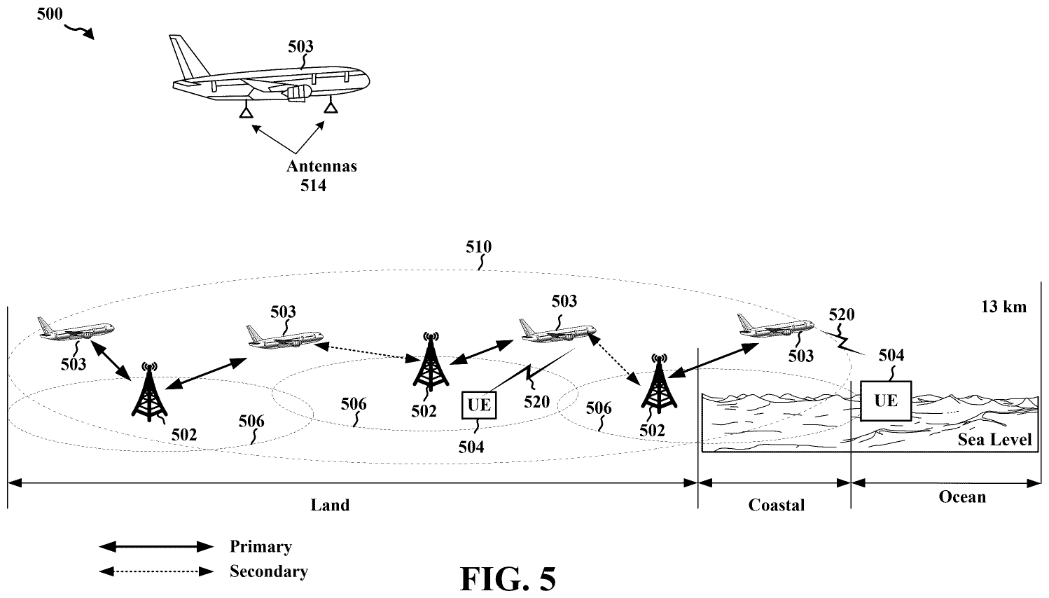

FIG. 5 is a diagram 500 illustrating wireless communications in an air-to-ground (ATG) ATG communication system 510. ATG communications may take place between aerial devices 103 (e.g., aircraft-borne devices) in the air and ground-based base stations 502 or gateways. An aircraft-borne device may refer to a device that is inside, attached to, or traveling with an aircraft. As illustrated in FIG. 5, the aerial device 503 may exchange ATG communication with ground-based (or terrestrial) base stations 502 when traveling over land and/or coastal areas. The ground-based base stations 502 may be equipped with antennas angled (e.g., up-tilted or positioned to transmit upward) for communication with aerial devices in flight and the aerial devices 503 may be equipped with a server and antennas 514 at the bottom and/or on the sides of the aircraft for communication with ground-based base stations 502. The aerial device 503 may travel in a path that crosses the coverage area 506 of various ground-based base stations 502. The aerial device 503 may provide on-board communication components, such as internal Wi-Fi antennas or other radio access technologies (RATs) to allow passengers to communicate with a ground-based base station 102 based on ATG communication. The data traffic that may be carried over ATG communications may include aircraft passenger communications (e.g., communications associated with the passengers' own devices, which may be available en route on commercial flights, and additionally during takeoff, landing, climb and/or descent for business aviation), airline operation communications (e.g., aircraft maintenance information, flight planning information, weather information, etc.), and/or air traffic control communications (e.g., the ATG communications may serve as a backup to systems operating in aviation licensed bands). As described herein, the aerial devices may also exchange communication 520 with one or more UEs 504, and may relay communication from a base station 502 to a UE 504, in accordance with aspects presented herein.

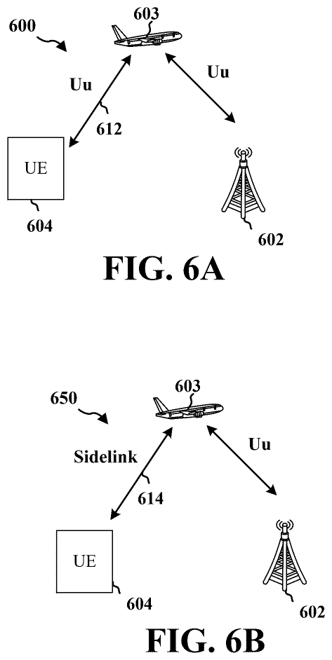

FIG. 6A is a diagram 600 illustrating a relay option for an aerial relay device 603, such as a commercial aircraft to relay messages or other communication between a UE 604 and a terrestrial base station 602. In some aspects, the aerial relay device 603 may relay emergency messaging between the UE 604 and the base station 602. In other aspects, the aerial relay device 603 may relay high priority messages between the UE 604 and the base station 602. In other aspects, the aerial relay device 603 may relay other communication, such as voice communication, between the UE 604 and the base station 602. In FIG. 6A, the aerial relay device 603 acts as a mobile base station relay to provide connectivity to a UE 604 that is out-of-coverage of a terrestrial network, and the aerial relay uses Uu over a radio link 612 to relay the communication to and from the UE 604. FIG. 6B is a diagram 650 illustrating a relay option for the aerial relay device 603 to relay communication between the UE 604 and the terrestrial base station 602 using sidelink for the radio link 614 between the aerial relay device 603 and the UE 604. In some aspects, the terrestrial base station 602 may operate as a donor base station, and the aerial relay device 603 may operate as an IAB node. The aerial relay device 603 may be referred to by various names including an aerial mobile relay, an aerial relay node, an aircraft mounted relay, an aircraft-borne relay, among other examples.

Compared to satellite-based communications (e.g., via an Iridium-like SatCom system or a satellite-based 3GPP NTN, which, for example, may be used when the aircraft is above an ocean), ATG communications may be associated with a lower cost, a higher throughput, and/or a lower latency, according to some examples. For example, the aerial device is located at a lower level than a satellite and may transmit and receive communication with a UE having less latency. Standardization of ATG communication may enable globally inter-operable deployments of ATG communication systems. In some aspects, ATG communication systems may allow for reduced deployment costs without launching satellites and may incorporate software upgrades for ATG communication. ATG communication may involve less user assistance in operating the device, e.g., not involving user positioned antennas, and may be incorporated into a device that provides wireless communication service within a cellular spectrum.

As described in connection with FIG. 3, a sidelink slot structure may include resources for PSSCH, PSCCH, and PSFCH. A control channel (e.g., PSCCH) may include information (e.g., sidelink control information (SCI)) for decoding the data channel, such as information about time and/or frequency resources that are allocated for the data channel transmission.

Sidelink communication may be based on different types or modes of resource allocation mechanisms. In a first resource allocation mode (which may be referred to herein as “Mode 1”), centralized resource allocation may be provided by a network entity. For example, a base station 102 or 180 may determine resources for sidelink communication and may allocate resources to different UEs 104 to use for sidelink transmissions. In this first mode, a UE receives the allocation of sidelink resources from the base station 102 or 180. In a second resource allocation mode (which may be referred to herein as “Mode 2”), distributed resource allocation may be provided. In Mode 2, each UE may autonomously determine resources to use for sidelink transmission. In order to coordinate the selection of sidelink resources by individual UEs, each UE may use a sensing technique to monitor for resource reservations by other sidelink UEs and may select resources for sidelink transmissions from unreserved resources. Devices communicating based on sidelink, may determine one or more radio resources in the time and frequency domain that are used by other devices in order to select transmission resources that avoid collisions with other devices. The sidelink transmission may use time and frequency resources based on a sidelink resource pool. In some aspects, sidelink communication may be configured for or designed for V2X communication and may be applicable to additional non-V2x services.

Additional aspects may provide for improved power savings for sidelink communication devices. Sidelink based relay of communication may provide for improved coverage or improved reliability for UE-to-network communication by enabling a UE to transmit communication for a network over sidelink to a relay (such as another UE) for transmission to the network. In some aspects, the sidelink relay may include a layer 3 (L3) relay or a layer 2 (L2) relay to extend sidelink connectivity. L3 relay may refer to IP layer relaying, and L2 relay may refer to RLC/MAC layer relaying. As an example, a relay may be performed at a vehicle mounted relay device (e.g., based on V2X). The relay may provide for improved positioning and/or ranging for sidelink capable devices. In other aspects, the sidelink relay may provide UE-to-UE relay in non-vehicle mounted applications.

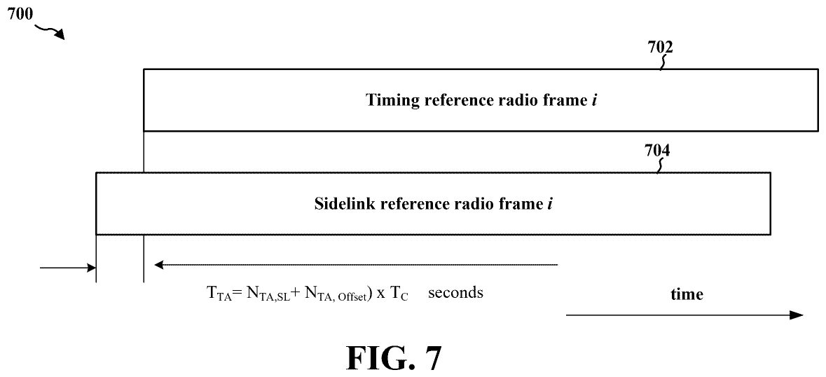

FIG. 7 illustrates a time diagram 700 showing a timing relation between a timing reference radio frame 702 and a sidelink reference radio frame 704. FIG. 7 shows a timing relation for sidelink communication, in which the UE applies a timing advance for sidelink communication in order to synchronize with a timing reference source, e.g., the timing 702. In contrast to FIG. 7, aspects presented herein may include a change in the timing of the transmission and reception of an aerial relay device by advancing the transmission timing relative to the reference timing and delaying the reception timing relative to the reference timing.

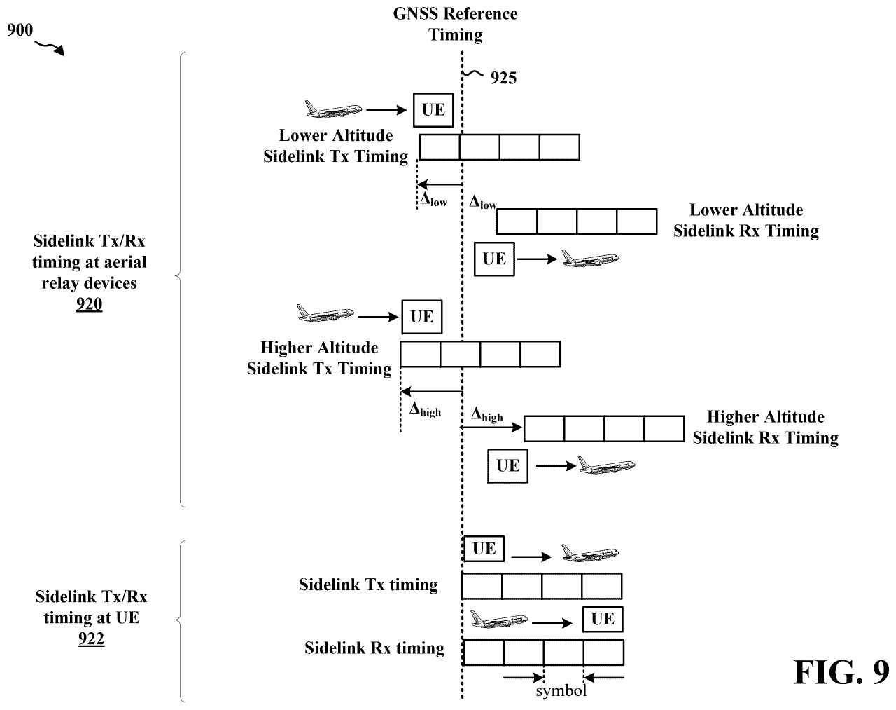

The timing of the sidelink reference radio frame 704 may start a time offset or time advance (T_{TA}) before the start of the corresponding timing reference radio frame 702. The time offset may be set to zero for sidelink communication. Therefore, the sidelink transmission frame timing may be the same as the sidelink reception frame timing, e.g., as illustrated for the sidelink transmission and reception timing 922 in FIG. 9.

Examples of a synchronization reference source may include a global navigation satellite system (GNSS), a base station (such as a gNB or eNB), a synchronization reference (SynchRef) UE, or a particular aerial relay device that may be used as a synchronization reference source. The synchronization reference source may be selected based on a priority rule that may prioritize use of one synchronization source over another.

In the example relay option in FIG. 6B, the aerial relay device 603 may provide relay of communication similar to a UE-to-UE relay in which a UE relays communication for another UE to a base station. The round trip time (RTT) between the aerial relay device 603 and the UE 604 is large compared to an RTT between two UEs on the ground. As an example, an altitude for an en-route aircraft may be between 6-13 km, and a propagation delay between the UE 604 and the aerial device 603 may be more than 40 μs, whereas two ground based UEs may exchange sidelink communication (e.g. V2X communication) at a distance of less than 300 meters with a propagation delay of less than 1 μs.

The longer propagation delay between a UE 604 and an aerial device 603 may result in a large offset in the sidelink transmission and reception timing at the UE 604 and the aerial device 603. Aspects presented herein provide for improved timing advance mechanisms that can be applied at an aerial device to address the transmission and reception timing between the UE 604 and the aerial device 603 for the increased propagation delay due to the altitude of the aerial device.

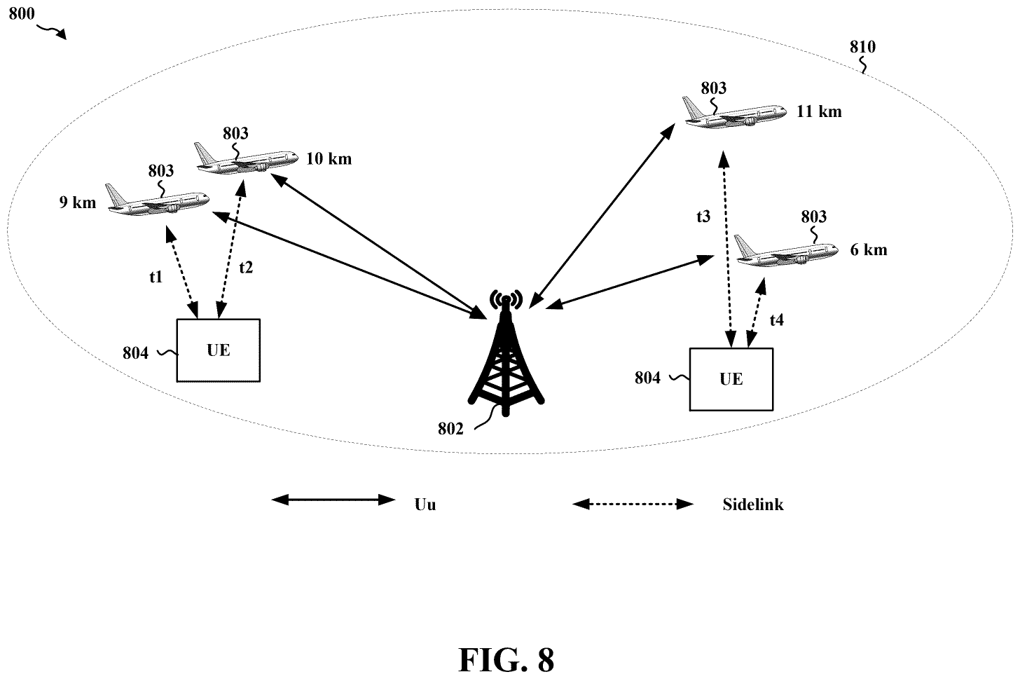

As illustrated in FIG. 8 a ground UE 804 in an ATG communication system 800 may transmit or receive sidelink communication with multiple aerial relays 803, and different aerial relays 803 may have lower or higher altitudes. For example, a ground UE may transmit an emergency message that is received by multiple aerial relays for reliability improvement. In some aspects, the distance between a ground UE and an aerial relay may be larger than for sidelink communication among ground UEs (e.g., V2X communications). In some aspects, the propagation delay difference between the ground UE and different aerial relays may be larger than the length of cyclic prefix of an OFDM symbol. Aspects presented herein provide for the UE 804 to transmit and receive sidelink communication with a wireless network via multiple aerial relay devices 803 and an ATG base station 802 using a same transmission and reception frame timing to exchange sidelink communication with more than one aerial relay device 803. FIG. 9 illustrate that the transmission and reception timing 922 at the UE may be the same for communicating with a lower altitude aerial relay device and a higher altitude aerial relay device because individual aerial relay devices may adjust the transmission and reception timing for communication with the UE.

The timing advance mechanism for an access link based on Uu may provide for alignment of downlink and uplink timing at a base station, and may be based on the UE being synchronized with a single base station. The base station may provide the UE with a timing advance that the UE applies when transmitting uplink communication to the base station, for example. If a similar timing advance mechanism were applied for sidelink communication with multiple aerial relay devices, the ground UE 804 may maintain multiple timing tracking loops for the different aerial relay devices 803 and may use a different transmission and reception frame timing for the different aerial relay devices 803. A timing tracking loop may refer to an ongoing synchronization procedure that the UE may use to continually adjust a timing relative to a particular aerial relay device. FIG. 8 illustrates that within the coverage 810 of the base station 802, the UE 804 may transmit or receive sidelink communication with multiple aerial relay devices 803 at different altitudes that lead to different propagation delays, e.g., t1 for an altitude of 9 km versus t2 for an altitude of 10 km and t3 for an altitude of 11 km versus t4 for an altitude of 6 km. The ground UE may transmit to or receive from a single aerial relay device at one time in order to accommodate the particular transmission and reception frame timing. In some aspects, the UE may switch between applying different transmission and reception frame timing adjustments as the UE switches between communication with different aerial relay devices.

Aspects presented herein provide for a timing adjustment at each aerial relay device 803 to enable the UE 804 to use a common transmission and reception timing with multiple aerial relay devices 803. The UE may be referred to as a ground UE or a ground-based UE. The UE 804 and/or the aerial relay device(s) 803 may be synchronized with a reference synchronization source, such as a GNSS. The synchronization may be direct, e.g., based on reception of a GNSS signal, or may be indirect and based on reception of a synchronization signal from another device using the GNSS as synchronization source.

Each aerial relay device that transmits or receives communication with the UE may apply a timing advance for the communication with the UE. FIG. 9 illustrates a time diagram 900 showing that a UE and multiple aerial relay devices may be synchronized to a reference time of a sidelink synchronization reference 925. In some aspects, the reference time may be a GNSS reference timing. The UE may transmit and/or receive communication with multiple aerial relay devices, including a lower altitude aerial relay device and a higher altitude aerial relay device using a common sidelink transmission and reception timing 922 that is aligned with the reference timing (e.g., 925). The aerial relay devices may apply a timing advance Δ prior to the reference timing (e.g., 925) when transmitting sidelink transmissions to the UE and may apply the timing advance Δ after the GNSS reference timing to monitor for sidelink communication from the UE. The transmission and reception timing at the aerial relay devices is shown at 920. The time may be smaller (e.g., Δ_{low}) for aerial relay devices at lower altitudes and may be longer (e.g., Δ_{high}) for aerial relay devices at higher altitudes.

In some aspects, the timing advance may include, or be based on, an en-route altitude of the aerial relay device. For example, the aerial relay device may transmit sidelink transmissions to one or more UEs at a sidelink transmission timing (t_{SL,Tx}) based on t_{SL,Tx}=t_{GNSS}−Δ and may monitor for sidelink transmissions from the UE(s) at a sidelink reception timing (t_{SL,Rx}) based on t_{SL,Rx}=t_{GNSS}+Δ, where t_{GNSS} is the GNSS reference timing, and A corresponds to, or is at least partially based on, the en-route altitude of the aerial device.

In some aspects, the value of the initial timing advance Δ may be signaled to the aerial relay device by the network, e.g., from a base station, to compensate for the propagation delay from the aerial relay device to the UE. The timing advance configuration for the aerial device may comprise of a set of timing advance values each associated with a different altitude value. In some aspects, the initial timing advance Δ may indicate a communication range, which may be referred to as a maximum discovery range for the aerial relay device by the UE. For example, a discovery message may be transmitted by the aerial relay device to the one or more UEs at a transmission time based on the initial timing advance relative to a reference time of a sidelink synchronization reference. If the actual delay between the aerial relay device and the UE is longer than the initial timing advance Δ, then the UE may not decode the discovery message transmitted by the aerial relay device.

By adjusting the sidelink transmission timing of the aerial relay device with an altitude specific timing advance, the UE at the ground may receive sidelink communication from different aerial relay devices simultaneously, e.g., overlapping at least partially in time, because the sidelink signals from different aerial relay devices will arrive at the UE at similar times based on the altitude specific timing compensation applied by the aerial relay devices.

Similarly, the altitude specific timing advance enables the sidelink transmission from the UE to be received by the aerial relay devices simultaneously, because the different aerial relay devices will adjust monitoring for sidelink transmissions from the UE based on the altitude specific timing advance to compensate the propagation delay from the UE to the aerial relay device. The UE may use a same transmission frame timing as the reception frame timing based on N_{TA,SL}=0, for example.

Although aspects have been described for an aerial relay device, and the figures illustrate an aircraft, the adjustment of the transmission and reception timing at the aerial device may similarly be applied for other aerial devices, such as a High Altitude Platforms (HAPs) including Unmanned Aircraft Systems (UAS).

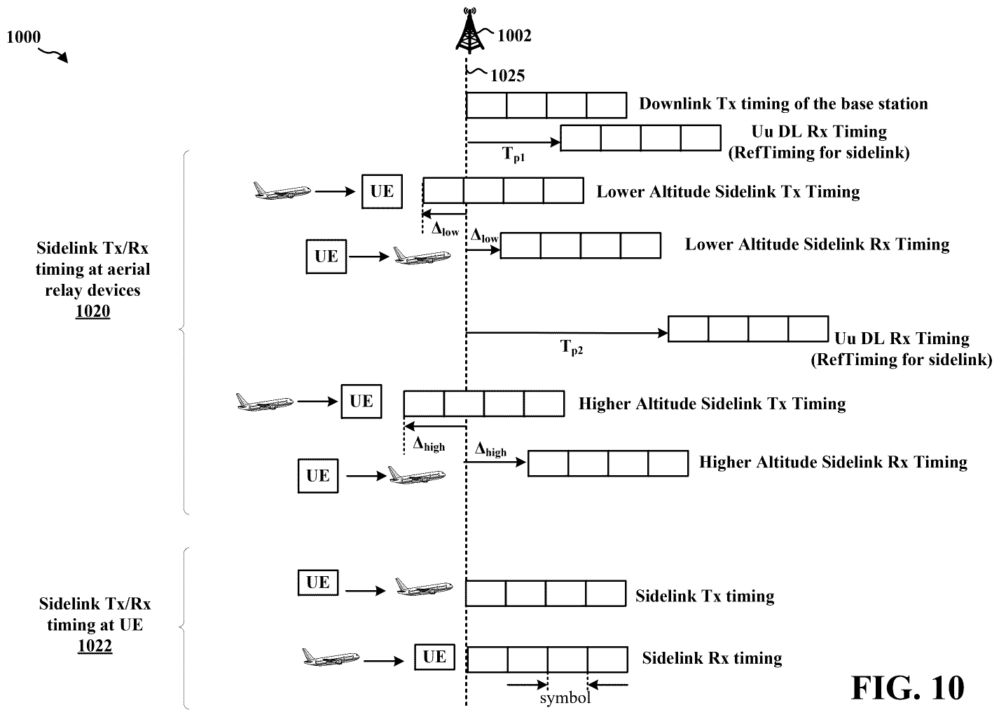

In some aspects, the UE and the aerial relay device may be synchronized to the timing of a base station, e.g., an ATG base station, as a synchronization reference source. In some aspects, the aerial relay device may be directly synchronized with the base station, e.g., based on reception of a synchronization signal or other reference signal from the base station. The UE may be indirectly synchronized with the base station, e.g., based on a reference signal or synchronization signal of another device that is synchronized with the base station. FIG. 10 illustrates an example time diagram 1000 showing synchronization with a reference time of a sidelink synchronization reference 1025. In some aspects, the reference time may be a downlink reference timing of a base station 1002. The base station may be an ATG base station, for example. In some aspects, an uplink timing advance for the Uu link may be applied in combination with the initial timing advance Δ to the sidelink transmission and reception frame timing of the aerial relay device, e.g., as illustrated at 1020. For example, the aerial relay device may transmit sidelink transmissions to one or more UEs at a sidelink transmission timing (t_{SL,Tx}) based on t_{SL,Tx}=t_{refDL}−Δ₁/2−Δ₂, and may monitor for sidelink transmissions from the UE(s) at a sidelink reception timing (t_{SL,Rx}) based on t_{SL,Rx}=t_{refDL}−Δ₁/2+Δ₂, where t_{refDL} is the downlink timing from the synchronization source, such as a base station. The parameter Δ₂ corresponds to the initial timing advance, and the value may be altitude dependent, e.g., as described in connection with FIG. 9. The parameter Δ₁ corresponds to an uplink timing advance for the aerial device to communicate with the base station.

In some aspects, the sidelink transmission and reception frame timing 1022 at the UE may be the same as the reference base station transmission and reception frame timing, e.g., as illustrated at 1020 in FIG. 10.

For aerial relay devices, due to the applied timing advance for sidelink communications with the ground UE, the reception frame timing may start later than the transmission frame timing. As described in connection with FIG. 9 and FIG. 10, the transmission frame timing may be moved to an earlier time based on an initial timing advance and/or the uplink timing advance for the Uu link, and the reception frame timing may be delayed based on similar offset(s). The misalignment of the sidelink transmission and reception frame timing may lead to collisions in time, e.g., an overlap in time, between sidelink reception and transmission for one or more UEs.

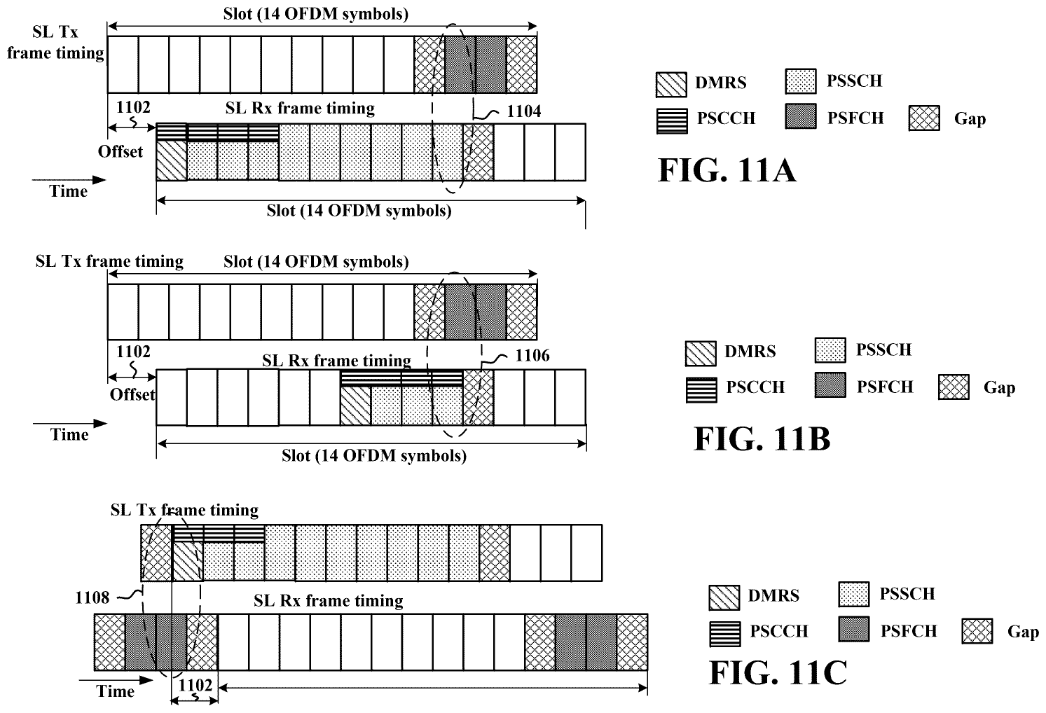

The values of the initial timing advance and/or the uplink timing advance for the Uu link can be larger than one OFDM symbol. If the offset is larger than 1 symbol, the 1 symbol gap in the sidelink slot structure for Tx/Rx switching may not accommodate the offset. FIGS. 11A, 11B, and 11C illustrate examples in which the offset 1102 between the sidelink transmission timing and the sidelink reception timing is larger than one symbol. The offset may lead to an overlap in time, e.g., as illustrated at 1104, 1106, and 1108 in FIGS. 11A-C, respectively, between sidelink reception and transmission for one or more UEs.

Aspects presented herein provide for collision handling when the offset between the sidelink transmission timing and the sidelink reception timing for the aerial relay device is large than one symbol.

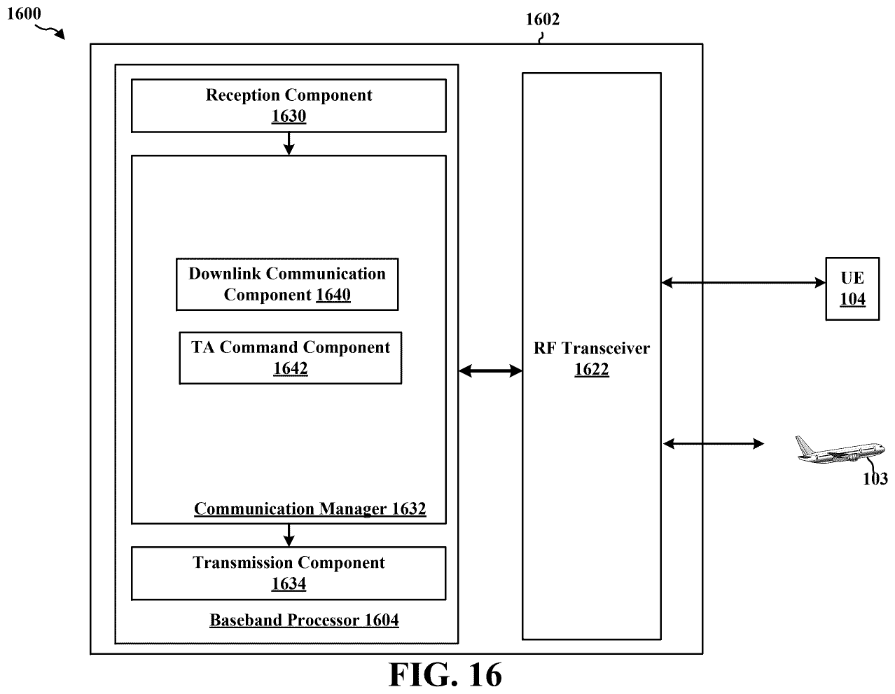

In some aspects, if PSSCH reception overlaps in time with PSFCH transmission, as shown in the example 1600 in FIG. 16, the aerial relay may transmit or receive only the channel, e.g., transmission, with the higher priority. The priority of the PSSCH may be determined by the SCI formats scheduling the transmission. The priority of the PSFCH may be the priority of the corresponding PSSCH for which feedback is to be provided.

In some aspects, if PSCCH monitoring overlaps in time with PSFCH transmission, e.g., as illustrated at 1106 in FIG. 11B, the aerial relay device may skip the PSFCH transmission and may monitor for the PSCCH. The PSCCH may be considered as having a higher priority than PSFCH transmission.

In some aspects, if PSFCH reception overlaps in time with PSSCH/PSFCH transmission, e.g., as illustrated at 1108 in FIG. 11C, the aerial relay device may skip the PSFCH reception and may transmit the PSSCH or PSFCH. The PSSCH or PSCCH transmission may be considered as having a higher priority than PSFCH reception.

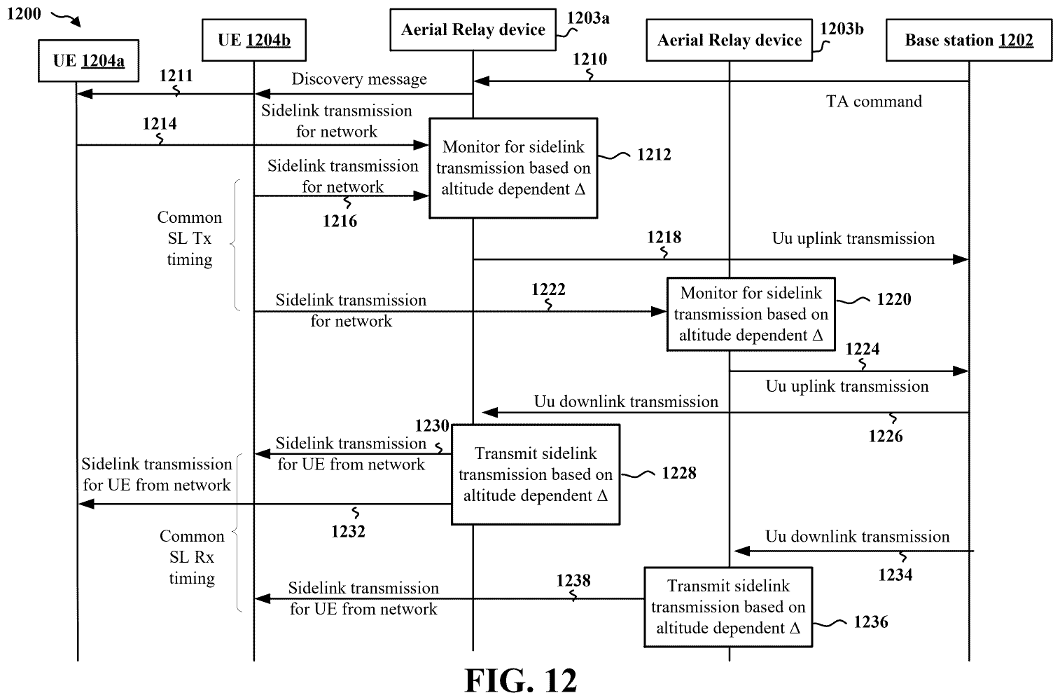

FIG. 12 illustrates an example communication flow 1200 between one or more UEs, e.g., 1204a and 1204b, and a base station 1202 (e.g., a terrestrial base station or a ground-based base station) via one or more aerial relay devices 1203a and 1203b. The UE(s) 1204a and 1204b transmit and receive sidelink communication with the aerial device 1203a or 1203b in order to communicate with the base station 1202. The aerial relay device 1203a and 1203b transmit uplink communication and receive downlink communication on a Uu link with the base station 1202. As described in connection with any of FIG. 9, 10, or 11, each aerial relay device 1203a or 1203b adjusts the sidelink transmission timing and sidelink reception timing. The UEs 1204a and 1204b may transmit and receive sidelink communication based on a reference timing source, e.g., without a timing adjustment for the aerial relay device. The aerial relay 1203a may receive a configuration indicating an initial timing advance for sidelink communication with one or more UEs. The initial timing advance may be based on the altitude of the aerial relay 1203a. The aerial relay 1203a may transmit a sidelink discovery message 1211 with a timing based on the initial timing advance indicated by the network and based on an altitude of the aerial relay 1203a. For example, the timing may include aspects described in connection with FIGS. 9 and/or 10.

As illustrated at 1212, the aerial relay device 1203a may monitor for sidelink communication 1214 or 1216 from one or more UEs at a reception time that is offset from the reference time based at least on an initial timing advance (e.g., +Δ) or (−Δ₁/2+Δ₂). The initial timing advance may be based on the altitude of the aerial relay device 1203a. In some aspects, the aerial relay device 1203a may receive the initial timing advance, and/or an uplink timing for the Uu link, from the base station 1202 at 1210. As the timing adjustment is a timing adjustment based on the altitude of the aerial relay device, the timing adjustment may be common to, shared by, or applicable for multiple UEs (e.g., ground-based UEs) that may have similar propagation distances to the aerial relay device 1203a. FIG. 12 illustrates an example in which the aerial relay device 1203a may receive a sidelink transmission 1214 for communication to the network from the UE 1204a and a sidelink transmission 1216 for communication to the network from the UE 1204b while monitoring at a reception time that is offset from the reference time based on the initial timing advance. The initial timing advance may provide a time following a synchronization source frame timing to allow for the propagation delay between the UEs and the aerial relay device 1203a. In some aspects, another aerial relay device 1203b may similarly monitor for sidelink communication 1222 from the UE 1204b based on an altitude dependent timing offset, at 1220. The aerial relay device 1203a and the aerial relay device 1203b may be at different altitudes, and therefore, may monitor for the sidelink communication based on different timing offsets. After receiving sidelink transmissions 1214, 1216, and 1222, the aerial relay devices 1203a and 1203b transmit the communication to the base station 1202 in uplink transmissions 1218 and 1224, respectively. The base station 1202 may transmit downlink transmissions 1226 and 1234 to the aerial relay devices 1203a and 1203b for communication to the UEs 1204a and 1204b. The aerial relay device 1228 transmits sidelink transmissions 1230 and 1232 to the UE 1204b and 1204a, respectively, at a sidelink transmission timing based at least on the initial timing advance (e.g., −Δ) or (−Δ₁/2−Δ₂), e.g., as illustrated at 1236. As the initial timing advance is a group common timing advance, the aerial relay device may apply it for the sidelink transmissions 1230 and 1232 to more than one UE. The aerial relay device 1203b transmits the sidelink transmission 1238 to the UE 1204b based at least on the group common timing advance (e.g., −Δ) or (−Δ₁/2−Δ₂). As the altitude of the aerial relay device 1203b may be different than that of the aerial relay device 1203a, the timing advance may also be different.

As the aerial relay devices 1203a and 1203b apply the timing advance to the sidelink communication, a UE, such as the UE 1204b may transmit to multiple aerial relay devices (e.g., 1203a and 1203b) based on a common sidelink transmission timing and may receive sidelink communication from multiple aerial relay devices (e.g., 1203a and 1203b) based on a common sidelink reception timing.

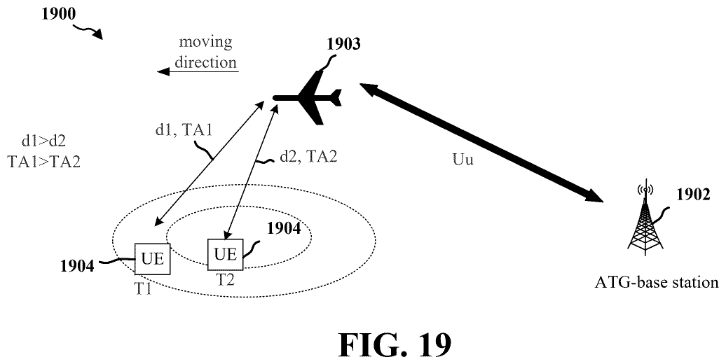

In some aspects, the aerial relay may adjust the transmission or reception frame timing for the sidelink communication with one or more UEs to account for a change in a propagation delay between the aerial relay and the UE (e.g. due to the movement of the aerial relay). FIG. 19 illustrates an example diagram 1900 showing relayed communication between a base station 1902 and a UE 104 via an aerial relay 1903. The aerial relay 1903 may adjust the sidelink transmission or reception timing for communication with the UE 1904 to account for a change in the propagation delay between the aerial relay 103 and the UE 104. As an example, the aerial relay may use a smaller timing advance as the aerial relay moves closer to the UE 1904, which may be referred to as a ground UE. The aerial relay 1903 may determine the timing advance update, e.g., based on the measurement of the reception timing for the sidelink transmissions from the UE 1904 to the aerial relay 1903. The aerial relay may determine a change in a propagation delay between the aerial relay 1903 and the UE 1904 based on the reception and measurement of timing for reception of sidelink communications from the UE 1904. In response to a change in a propagation delay, the aerial relay 1903 may adjust both the transmission and reception timing for sidelink communication with the UE 1904. FIG. 19, illustrates that at time T1, the aerial relay 1903 may determine a first propagation delay (d1) for UE 1904 may apply a corresponding timing advance (TA1) to sidelink transmission and reception with the UE. At time T2, the aerial relay 1903 may determine a second propagation delay (d2) for UE 1904 may apply a corresponding timing advance (TA2) to sidelink transmission and reception with the UE. As d1> that d2, the timing advance TA1 may be greater than TA2. In some aspects, a TA may not be expected to be larger than a configured initial timing advance from a base station. For example, the aerial relay may determine to skip communication if the determined TA is larger than the configured initial timing advance from a base station when the UE 1904 is out-of-coverage of the aerial relay 1903.

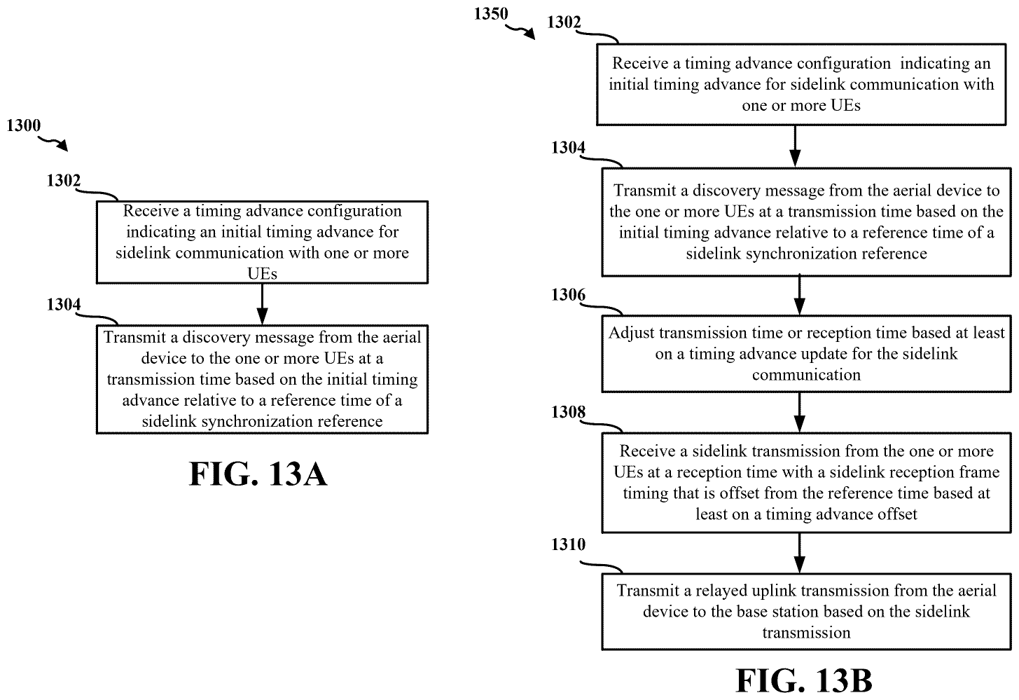

FIG. 13A is a flowchart 1300 of a method of wireless communication. The method may be performed by an aerial device (e.g., the aerial relay 103, 603, 803, 1203a, 1203b; the aerial device 503; the device 410; the apparatus 1402). The method may improve reliability of communication between a UE and the base station that is relayed via the aerial device through a timing adjustment at the aerial device that enables a UE to communicate via multiple aerial devices simultaneously.

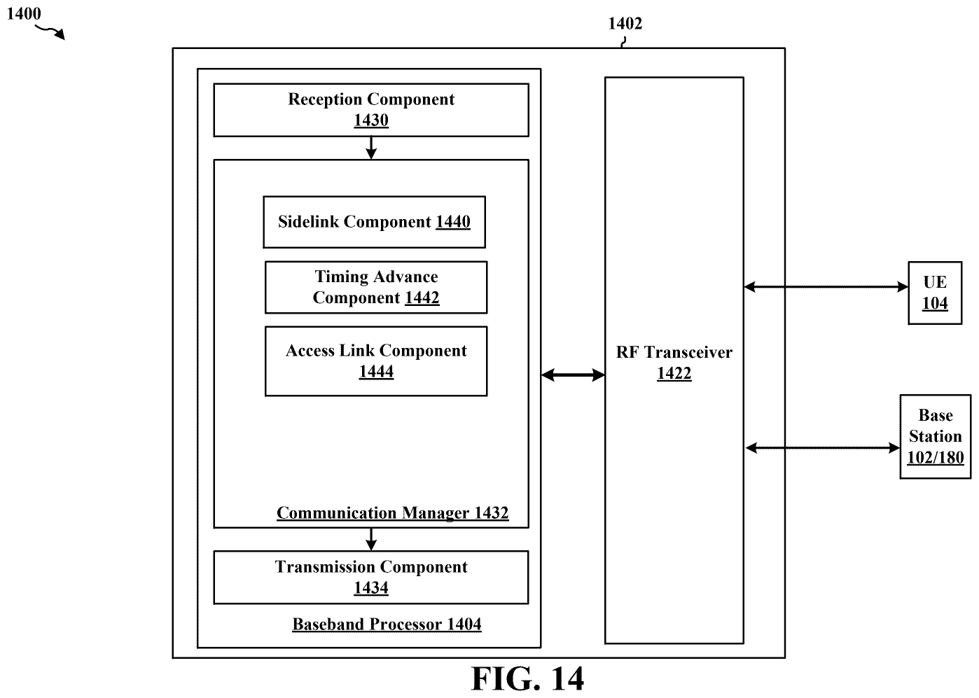

At 1302, the aerial device receives a timing advance configuration from a base station for sidelink communication with one or more UEs, the timing advance configuration indicating an initial timing advance for the sidelink communication with the one or more UEs. The reception may be performed, e.g., by the timing advance component 1442 via the reception component 1430 and/or RF transceiver 1422 of the apparatus 1402 in FIG. 14. FIG. 8 illustrates an example of an aerial device receiving communication from a base station for relay to a UE by an aerial device. FIG. 12 illustrates an example of an aerial device receiving downlink communication on a Uu link for communication over sidelink to one or more UEs.

At 1304, the aerial device transmits a discovery message from the aerial device to the one or more UEs at a transmission time based on the initial timing advance relative to a reference time of a sidelink synchronization reference. The timing advance configuration for the aerial device may include a set of timing advance values each associated with a different altitude value. The aerial device may apply a timing advance value that is associated with the aerial device's current altitude. The sidelink synchronization reference may be a GNSS signal or a base station. When the sidelink synchronization reference is the base station, the aerial device may transmit the discovery message to the one or more UEs at the transmission time based on the initial timing advance and an uplink timing advance for communications with the base station.

The aerial device may transmit relayed sidelink communication from the aerial device to the one or more UEs at a transmission time based on an initial timing advance relative to a reference time. In some aspects, the initial timing advance may be referred to as a common timing advance, e.g., that is common to multiple UEs. The transmission may be performed, e.g., by the sidelink component based on the initial timing advance provided by the timing advance component via the transmission component 1434 and/or the RF transceiver 1422 of the apparatus 1402 in FIG. 14. The initial timing advance for the aerial device may be based on a current altitude of the aerial device. FIG. 9 illustrates an example based on synchronization with a GNSS synchronization source and in which the aerial device applies a group common timing advance (e.g., −Δ).

Transmitting the relayed sidelink communication from the aerial device to the one or more UEs may include transmitting a relayed sidelink transmission to the one or more UEs at the transmission time based on the initial timing advance and an uplink timing advance for the Uu link. FIG. 10 illustrates an example based on alignment with a base station's downlink timing as a synchronization source and in which the aerial device applies both an altitude specific timing advance and an uplink timing advance for the Uu link (−Δ₁/2−Δ₂).

FIG. 13B is a flowchart 1350 of a method of wireless communication that may be performed by an aerial device and which may include 1302 and 1304 as described in connection with FIG. 13A. illustrated at 1302, the aerial device may receive an indication of the initial timing advance from the base station. FIG. 12 illustrates an example of an aerial device receiving an indication of the time offset from a base station. The reception may be performed by the timing advance component 1442 via the reception component 1430 and/or the RF transceiver 1422 of the apparatus 1402 in FIG. 14.

At 1308, the aerial device may receive a sidelink transmission from a UE at a reception time with a sidelink reception frame timing that is offset from the reference time based at least on an initial timing advance. The reception may be performed, e.g., by the sidelink component based on the timing from the timing advance component 1442 and via the reception component 1430 and/or the RF transceiver 1422 of the apparatus 1402 in FIG. 14. A sidelink reception frame timing may be offset from a reference timing based at least on an initial timing advance (e.g., +Δ). FIG. 9 illustrates an example based on synchronization with a GNSS synchronization source and in which the aerial device applies a group common timing advance (e.g., +Δ) to receive sidelink communication. Monitoring for the sidelink communication may include monitoring for a sidelink transmission from a UE at a reception time that is offset from the reference time based on the initial timing advance and an uplink timing advance for the Uu link. FIG. 10 illustrates an example based on alignment with a base station's downlink timing is the reference time of the sidelink synchronization source and in which the aerial device applies both an altitude-specific timing advance and an uplink timing advance for the Uu link (−Δ₁/2+Δ₂).

At 1310, the aerial device may transmit a relayed uplink transmission from the aerial device to the base station based on the sidelink transmission. FIG. 12 illustrates an example of an aerial device transmitting an uplink transmission to a base station to device the sidelink communication received from the one or more UEs. The transmission may be performed, e.g., by the access link component 1444 via the transmission component 1434 and/or the RF transceiver 1422 of the apparatus 1402 in FIG. 14.

As illustrated at 1306, the aerial device may adjust the transmission time or the reception time based at least on a timing advance update for the sidelink communications, the timing advance update being based on a propagation delay between the aerial device and the one or more UEs.

In some aspects, as part of the reception at 1308 and the transmission at 1306, the aerial device may handle collisions between transmission and reception resources, e.g., based on an offset between the sidelink transmission timing and the sidelink reception timing, e.g., as described in connection with any of FIGS. 11A-C. In some aspects, the aerial device may transmit or receive a higher priority channel in response to an overlap in time between a PSSCH and a PSFCH, e.g., as described in connection with FIG. 11A. A channel priority may be based on SCI scheduling the PSSCH or the PSFCH. A priority of the PSFCH may be based on a corresponding PSSCH. The aerial device may skip transmission or reception of a lower priority channel between the PSSCH and the PSFCH. In some aspects, the aerial device may monitor for a PSCCH and skip transmission of a PSFCH that overlaps in time with the PSCCH, e.g., as described in connection with FIG. 11B. In some aspects, the aerial device may transmit a PSSCH or a first PSFCH and skip reception of a second PSFCH that overlaps in time with transmission of the PSSCH or the first PSFCH, e.g., as described in connection with FIG. 11C.

FIG. 14 is a diagram 1400 illustrating an example of a hardware implementation for an apparatus 1402. The apparatus 1402 may be an aerial device (e.g., aerial relay 103), a component of an aerial device, or may implement aerial device functionality. In some aspects, the apparatus 1402 may include a baseband unit 1404. The baseband unit 1404 may communicate through an RF transceiver 1422 with the UE 104. The baseband unit 1404 may include a computer-readable medium/memory. The baseband unit 1404 is responsible for general processing, including the execution of software stored on the computer-readable medium/memory. The software, when executed by the baseband unit 1404, causes the baseband unit 1404 to perform the various functions described supra. The computer-readable medium/memory may also be used for storing data that is manipulated by the baseband unit 1404 when executing software. The baseband unit 1404 further includes a reception component 1430, a communication manager 1432, and a transmission component 1434. The communication manager 1432 includes the one or more illustrated components. The components within the communication manager 1432 may be stored in the computer-readable medium/memory and/or configured as hardware within the baseband unit 1404. The baseband unit 1404 may be a component of the device 410 and may include the memory 476 and/or at least one of the TX processor 416, the RX processor 470, and the controller/processor 475.

The communication manager 1432 includes a sidelink component 1440 that is configured to transmit a discovery message from the aerial device to the one or more UEs at a transmission time based on the initial timing advance relative to a reference time of a sidelink synchronization reference, e.g., as described in connection with 1302 in FIG. 13A or 13B. The sidelink component 1440 may be configured to transmit relayed sidelink communication from the aerial device to the UE(s) at a transmission time based on an initial timing advance relative to a reference time and/or receive a sidelink transmission from the one or more UEs at a reception time based on the initial timing advance relative to the reference time, e.g., as described in connection with 1304, 1306, and/or 1308 in FIG. 13B. The communication manager 1432 further includes an access link component 1444 that is configured to receive a timing advance configuration indicating an initial timing advance for the sidelink communication with the one or more UEs. The access link component may be further configured to receive downlink communication from a base station for the one or more UEs and/or transmit a relayed uplink transmission from the aerial device to the base station based on the sidelink transmission, e.g., as described in connection with 1306 or 1308 in FIG. 13B. The communication manager 1432 further includes a timing advance component 1442 that is configured to apply a time offset based at least on a timing advance, e.g., as described in connection with 1306 and/or 1308 in FIG. 13B. In some aspects, the timing advance component 1442 may be configured to receive a timing advance configuration indicating an initial timing advance for the sidelink communications and/or a UE specific timing advance from a base station, e.g., as described in connection with 1302 in FIG. 13A or 13B. The sidelink component 1440 may be configured to transmit a discovery message from the aerial device to the one or more UEs at a transmission time based on the initial timing advance relative to a reference time of a sidelink synchronization reference, e.g., as described in connection with 1304 in FIG. 13A or 13B.

The apparatus may include additional components that perform each of the blocks of the algorithm in the flowcharts of FIG. 13A or 13B, and/or the aspects performed by the aerial device in any of FIGS. 8-12. As such, each block in the flowcharts of FIG. 13A or 13B, and/or the aspects performed by the aerial device in any of FIGS. 8-12 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 1402 may include a variety of components configured for various functions. In one configuration, the apparatus 1402, and in particular the baseband unit 1404, includes means for receiving a timing advance configuration from a base station for sidelink communication with one or more UEs, the timing advance configuration indicating an initial timing advance for the sidelink communication. The apparatus 1402 includes means for transmitting a discovery message from the aerial device to the one or more UEs at a transmission time based on the initial timing advance relative to a reference time of a sidelink synchronization reference. The apparatus 1402 may further include means for transmitting the discovery message to the one or more UEs at the transmission time based on the initial timing advance and an uplink timing advance for communications with the base station. The apparatus 1402 may further include means for transmitting a relayed sidelink transmission to the one or more UEs at the transmission time based on the initial timing advance and a UE specific timing advance relative to the reference time. The apparatus 1402 may further include means for receiving a sidelink transmission from the one or more UEs at a reception time with a sidelink reception frame timing that is offset from the reference time based at least on a timing advance offset. The apparatus 1402 may further include means for transmitting a relayed uplink transmission from the aerial relay to the base station based on the sidelink transmission. The apparatus 1402 may further include means for adjusting the transmission time or the reception time based at least on a timing advance update for the sidelink communications, the timing advance update being based on a propagation delay between the aerial device and the one or more UEs. The apparatus 1402 may further include means for transmitting or receiving a higher priority channel in response to an overlap in time between reception of a PSSCH and a PSFCH. The apparatus 1402 may further include means for skipping transmission or reception of a lower priority channel between the PSSCH and the PSFCH. The apparatus 1402 may further include means for monitoring for a PSCCH and skipping transmission of a PSFCH that overlaps in time with the PSCCH. The apparatus 1402 may further include means for transmitting a PSCCH or a first PSFCH and skipping reception of a second PSFCH that overlaps in time with transmission of the PSSCH or the first PSFCH. The means may be one or more of the components of the apparatus 1402 configured to perform the functions recited by the means. As described supra, the apparatus 1402 may include the TX Processor 416, the RX Processor 470, and the controller/processor 475. As such, in one configuration, the means may be the TX Processor 416, the RX Processor 470, and the controller/processor 475 configured to perform the functions recited by the means.

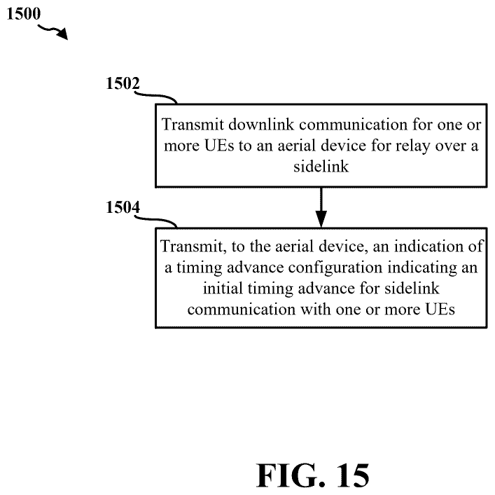

FIG. 15 is a flowchart 1500 of a method of wireless communication. The method may be performed by a base station (e.g., the base station 102/180, 502, 602, 802, 1202; the device 450; the apparatus 1602. The method may improve reliability of communication between a UE and the base station that is relayed via an aerial device by providing the aerial device with timing adjustment information, the application of which may enable a UE to communicate via multiple aerial devices simultaneously.

At 902, the base station transmits downlink communication for one or more UEs to an aerial device for relay over a sidelink. The transmission may be performed, e.g., by the downlink communication component 1640 via the transmission component 1634 and/or the RF transceiver 1622 of the apparatus 1602 in FIG. 16. FIG. 8 illustrates an example of a base station exchanging communication with a UE via multiple aerial devices. FIG. 12 illustrates an example of a base station transmitting communication to via multiple aerial devices.

At 904, the base station transmits to the aerial device, an indication of a timing advance configuration for sidelink communication with the one or more UEs, the timing advance configuration indicating an initial timing advance for the sidelink communication. The initial timing advance may be based on a current altitude of the aerial device. FIG. 9 illustrates an example based on synchronization with a GNSS synchronization source and in which the aerial device applies an initial timing advance offset, which may be referred to as a group common timing advance offset. FIG. 10 illustrates an example based on alignment with a base station's downlink timing as a synchronization source and in which the aerial device applies both an initial timing advance (e.g., a group common timing advance offset) and an uplink timing advance for the Uu link. FIG. 12 illustrates an example of a base station indicating the time offset to an aerial device. The transmission may be performed, e.g., by the TA command component 1642 via the transmission component 1634 and/or the RF transceiver 1622 of the apparatus 1602 in FIG. 16.

FIG. 16 is a diagram illustrating an example 1600 of a hardware implementation for an apparatus 1602. The apparatus 1602 may be a base station 102 or 180, a component of a base station, or may implement base station functionality. In some aspects, the apparatus 1602 may include a baseband unit 1604. The baseband unit 1604 may communicate through an RF transceiver 1622 with the UE 104. The baseband unit 1604 may include a computer-readable medium/memory. The baseband unit 1604 is responsible for general processing, including the execution of software stored on the computer-readable medium/memory. The software, when executed by the baseband unit 1604, causes the baseband unit 1604 to perform the various functions described supra. The computer-readable medium/memory may also be used for storing data that is manipulated by the baseband unit 1604 when executing software. The baseband unit 1604 further includes a reception component 1630, a communication manager 1632, and a transmission component 1634. The communication manager 1632 includes the one or more illustrated components. The components within the communication manager 1632 may be stored in the computer-readable medium/memory and/or configured as hardware within the baseband unit 1604. The baseband unit 1604 may be a component of the device 450 and may include the memory 460 and/or at least one of the TX processor 468, the RX processor 456, and the controller/processor 459. In one configuration, the apparatus 1802 may be a modem chip and include just the baseband processor 1804, and in another configuration, the apparatus 1802 may be the entire base station (e.g., see 450 of FIG. 4) and include the additional modules of the apparatus 1802.

The communication manager 1632 includes a downlink communication component 1640 that is configured to transmit downlink communication for one or more UEs to an aerial device for relay over a sidelink, e.g., as described in connection with 1502 in FIG. 15. The communication manager 1632 further includes a TA command component 1642 that is configured to transmit, to the aerial device, an indication of a timing advance configuration for sidelink communication to the one or more UEs, the timing advance configuration indicating an initial timing advance for the sidelink communications, e.g., as described in connection with 1504 in FIG. 15.

The apparatus may include additional components that perform each of the blocks of the algorithm in the flowchart of FIG. 15, and/or the aspects performed by the base station in any of FIGS. 8-12. As such, each block in the flowchart of FIG. 15, and/or the aspects performed by the base station in any of FIGS. 8-12 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 1602 may include a variety of components configured for various functions. In one configuration, the apparatus 1602, and in particular the baseband unit 1604, includes means for transmitting downlink communication for one or more UEs to an aerial device for relay over a sidelink and means for transmitting, to the aerial device, an indication of a timing advance configuration for sidelink communication with the one or more UEs, the timing advance configuration indicating an initial timing advance for the sidelink communications. The means may be one or more of the components of the apparatus 1602 configured to perform the functions recited by the means. As described supra, the apparatus 1602 may include the device 450 and may include the memory 460 and/or at least one of the TX processor 468, the RX processor 456, and the controller/processor 459. As such, in one configuration, the means may be the device 450 and may include the memory 460 and/or at least one of the TX processor 468, the RX processor 456, and the controller/processor 459 configured to perform the functions recited by the means.

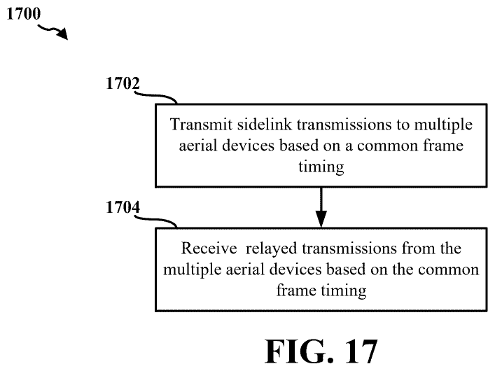

FIG. 17 is a flowchart 1700 of a method of wireless communication. The method may be performed by a UE (e.g., the UE 104, 604, 804, 1204a, 1204b; the device 450, the apparatus 1802). The method enables the UE to exchange sidelink communication with multiple aerial devices simultaneously and improves the reliability of communication with a network via aerial devices, such as aerial relays.

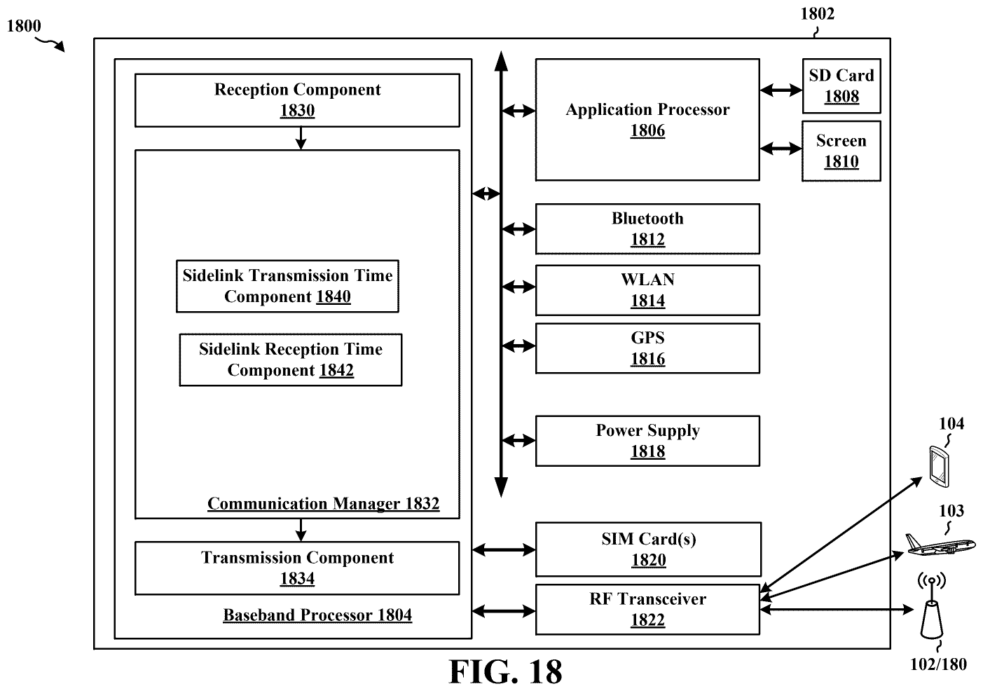

At 1702, the UE transmits sidelink transmissions to multiple aerial devices based on a common frame timing. The sidelink transmissions to the multiple aerial devices may overlap at least partially in time. The common timing may be based on a reference time without a timing advance for individual aerial devices. FIGS. 9 and 10 illustrate examples of the UE transmitting and receiving sidelink communication based on a common reference timing. FIG. 9 illustrates an example in which the UE's sidelink transmission and reception timing are aligned with a GNSS synchronization source. FIG. 10 illustrates an example in which the UE's sidelink transmission and reception timing are aligned with a base station's downlink timing as a synchronization source. FIG. 8 illustrates an example of a UE exchanging communication with a base station via multiple aerial relay devices. FIG. 12 illustrates an example of a UE transmitting sidelink communication to multiple aerial relay devices based on a common sidelink transmission timing. The transmission may be performed, e.g., by the sidelink transmission time component 1840 via the transmission component 1834 and/or the RF transceiver 1822 of the apparatus 1802 in FIG. 18.

At 1704, the UE receives relayed transmissions from the multiple aerial devices based on the common frame timing. FIGS. 9 and 10 illustrate examples of the UE receiving sidelink communication based on a common reference timing, e.g., a frame timing that is the same for transmission and reception at the UE and which is used for sidelink communication with aerial relay devices at various altitudes. FIG. 8 illustrates an example of a UE exchanging communication with a base station via multiple aerial relay devices. FIG. 12 illustrates an example of a UE receiving sidelink communication from multiple aerial relay devices based on a common sidelink reception timing. The reception may be performed, e.g., by the sidelink reception time component 1842 via the reception component 1830 and/or the RF transceiver 1822 of the apparatus 1802 in FIG. 18

FIG. 18 is a diagram 1800 illustrating an example of a hardware implementation for an apparatus 1802. The apparatus 1802 may be a UE, a component of a UE, or may implement UE functionality. In some aspects, the apparatus 1802 may include a baseband processor 1804 (also referred to as a modem) coupled to a RF transceiver 1822. In some aspects, the baseband processor 1804 may be a cellular baseband processor and/or the RF transceiver 1822 may be a cellular RF transceiver. The apparatus 1802 may further include one or more subscriber identity modules (SIM) cards 1820, an application processor 1806 coupled to a secure digital (SD) card 1808 and a screen 1810, a Bluetooth module 1812, a wireless local area network (WLAN) module 1814, a Global Positioning System (GPS) module 1816, and/or a power supply 1818. The baseband processor 1804 communicates through the RF transceiver 1822 with the UE 104 and/or BS 102/180. The baseband processor 1804 may include a computer-readable medium/memory. The computer-readable medium/memory may be non-transitory. The baseband processor 1804 is responsible for general processing, including the execution of software stored on the computer-readable medium/memory. The software, when executed by the baseband processor 1804, causes the baseband processor 1804 to perform the various functions described in the present application. The computer-readable medium/memory may also be used for storing data that is manipulated by the baseband processor 1804 when executing software. The baseband processor 1804 further includes a reception component 1830, a communication manager 1832, and a transmission component 1834. The communication manager 1832 includes the one or more illustrated components. The components within the communication manager 1832 may be stored in the computer-readable medium/memory and/or configured as hardware within the baseband processor 1804. The baseband processor 1804 may be a component of the device 450 and may include the memory 460 and/or at least one of the TX processor 468, the RX processor 456, and the controller/processor 459. In one configuration, the apparatus 1802 may be a modem chip and include just the baseband processor 1804, and in another configuration, the apparatus 1802 may be the entire UE (e.g., see 450 of FIG. 4) and include the additional modules of the apparatus 1802.

The communication manager 1832 includes a sidelink transmission time component 1840 that is configured to transmit sidelink transmissions to multiple aerial devices based on a common frame timing, e.g., as described in connection with 1702 in FIG. 17. The communication manager 1832 further includes a sidelink reception time component 1842 that is configured to receive relayed transmissions from the multiple aerial devices based on the common frame timing, e.g., as described in connection with 1704 in FIG. 17.

The apparatus may include additional components that perform each of the blocks of the algorithm in the flowchart of FIG. 17, and/or the aspects performed by the UE in any of FIGS. 8-12. As such, each block in the flowcharts of flowchart of FIG. 17, and/or the aspects performed by the UE in any of FIGS. 8-12 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1802, and in particular the baseband processor 1804, includes means for transmitting sidelink transmissions to multiple aerial devices based on a common frame timing and means for receiving relayed transmissions from the multiple aerial devices based on the common frame timing. The means may be one or more of the components of the apparatus 1802 configured to perform the functions recited by the means. As described herein, the apparatus 1802 may include the TX Processor 468, the RX Processor 456, and the controller/processor 459. As such, in one configuration, the means may be the TX Processor 468, the RX Processor 456, and the controller/processor 459 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

The following example aspects are illustrative only and may be combined with aspects of other examples or teachings described herein, without limitation.

Aspect 1 is a method of wireless communication at an aerial device, comprising receiving a timing advance configuration from a base station for sidelink communication to one or more UEs, the timing advance configuration indicating an initial timing advance for the sidelink communication with the one or more UEs; and transmitting a discovery message from the aerial device to the one or more UEs at a transmission time based on the initial timing advance relative to a reference time of a sidelink synchronization reference.

In aspect 2, the method of aspect 1 further includes that the timing advance configuration for the aerial device comprises of a set of timing advance values each associated with a different altitude value.

In aspect 3, the method of aspect 1 or aspect 2 further includes that a value of the initial timing advance is based on a current altitude of the aerial device.

In aspect 4, the method of any of aspects 1-3 further includes that the reference time of the sidelink synchronization reference is the base station, the transmitting the discovery message from the aerial device to the one or more UEs further includes: transmitting the discovery message to the one or more UEs at the transmission time based on the initial timing advance and an uplink timing advance for communications with the base station.

In aspect 5, the method of any of aspects 1-4 further includes receiving a sidelink transmission from the one or more UEs at a reception time with a sidelink reception frame timing that is offset from the reference time based at least on the initial timing advance.

In aspect 6, the method of aspect 5 further includes adjusting the transmission time or the reception time based at least on a timing advance update for the sidelink communication with the one or more UEs, the timing advance update being based on a propagation delay between the aerial device and the one or more UEs.

In aspect 7, the method of any of aspects 1-6 further includes transmitting or receiving a higher priority channel in response to an overlap in time between a PSSCH and a PSFCH.

In aspect 8, the method of aspect 7 further includes that a channel priority is based on SCI scheduling the PSSCH or the PSFCH.

In aspect 9, the method of aspect 7 further includes that a priority of the PSFCH is based on a corresponding PSSCH.

In aspect 10, the method of any of aspects 7-9 further includes skipping transmission or reception of a lower priority channel between the PSSCH and the PSFCH.

In aspect 11, the method of any of aspects 1-6 further includes monitoring for a PSCCH and skipping transmission of a PSFCH that overlaps in time with the PSCCH.

Aspect 12 is an apparatus for wireless communication including at least one processor coupled to a memory, the memory and the at least one processor configured to perform the method of any of aspects 1 to 11.

In aspect 13, the apparatus of aspect 12 further includes at least one antenna coupled to the at least one processor.

In aspect 14, the apparatus of aspect 12 or aspect 13 further includes a transceiver coupled to the at least one processor.

Aspect 15 is an apparatus for wireless communication including means for implementing any of aspects 1 to 12.

In aspect 16, the apparatus of aspect 14 further includes at least one antenna coupled to the means for implementing any of aspects 1 to 12.

In aspect 17, the apparatus of aspect 16 or aspect 17 further includes a transceiver coupled to the means for implementing any of aspects 1 to 12.

Aspect 18 is a computer-readable medium storing computer executable code, where the code when executed by a processor causes the processor to implement any of aspects 1 to 12.

Aspect 19 is a method of wireless communication at a base station including transmitting downlink communication for one or more UEs to an aerial device for relay over a sidelink; and transmitting, to the aerial device, an indication of a timing advance configuration for sidelink communication with the one or more UEs, the timing advance configuration indicating an initial timing advance for the sidelink communications.

In aspect 20, the method of aspect 19 further includes that the initial timing advance is based on a current altitude of the aerial device.

Aspect 21 is an apparatus for wireless communication including at least one processor coupled to a memory, the memory and the at least one processor configured to perform the method of aspect 19 or 20.

In aspect 22, the apparatus of aspect 21 further includes at least one antenna the at least one processor.

In aspect 23, the apparatus of aspect 21 or aspect 22 further includes a transceiver coupled to the at least one processor.

Aspect 24 is an apparatus for wireless communication including means for implementing any of aspect 19 or 20.

In aspect 25, the apparatus of aspect 24 further includes at least one antenna coupled to the at least one antenna.

In aspect 26, the apparatus of aspect 24 or aspect 25 further includes a transceiver coupled to the means for implementing aspect 19 or 20.

Aspect 27 is a computer-readable medium storing computer executable code, where the code when executed by a processor causes the processor to implement any of aspect 19 or 20.

Aspect 28 is a method of wireless communication at a user equipment (UE), comprising: transmitting sidelink transmissions to multiple aerial devices based on a common frame timing; and receiving relayed transmissions from the multiple aerial devices based on the common frame timing.

In aspect 29, the method of aspect 28 further includes that the sidelink transmissions to the multiple aerial devices overlap at least partially in time.

In aspect 30, the method of aspect 28 or aspect 29 further includes that the common frame timing is based on a reference time without a timing advance for individual aerial devices.

Aspect 31 is an apparatus for wireless communication including at least one processor coupled to a memory, the memory and the at least one processor configured to perform the method of any of aspects 28-30.

In aspect 32, the apparatus of aspect 31 further includes at least one antenna coupled to the at least one processor.

In aspect 33, the apparatus of aspect 31 or aspect 32 further includes a transceiver coupled to the at least one processor.

Aspect 34 is an apparatus for wireless communication including means for implementing any of aspects 28-30.

In aspect 35, the apparatus of aspect 34 further includes at least one antenna coupled to the at least one antenna.

In aspect 36, the apparatus of aspect 34 or aspect 35 further includes a transceiver coupled to the means for implementing any of aspects 28-30.

Aspect 37 is a computer-readable medium storing computer executable code, where the code when executed by a processor causes the processor to implement any of aspects 28-30.

What is claimed is:

1. An apparatus for wireless communication at an aerial device, comprising:
memory; and
at least one processor coupled to the memory, the memory and the at least one processor configured to:
receive a timing advance configuration from a base station for sidelink communication with one or more user equipments (UEs), the timing advance configuration indicating an initial timing advance for the sidelink communication with the one or more UEs; and
transmit a discovery message from the aerial device to the one or more UEs at a transmission time based on the initial timing advance relative to a reference time of a sidelink synchronization reference.

2. The apparatus of claim 1, wherein the timing advance configuration for the aerial device comprises a set of timing advance values each associated with a different altitude value.

3. The apparatus of claim 1, wherein a value of the initial timing advance is based on a current altitude of the aerial device.

4. The apparatus of claim 1, wherein the reference time of the sidelink synchronization reference is a time of the base station, and to transmit the discovery message from the aerial device to the one or more UEs, the memory and the at least one processor are further configured to:
transmit the discovery message to the one or more UEs at the transmission time based on the initial timing advance and an uplink timing advance for communication with the base station.

5. The apparatus of claim 1, wherein the memory and the at least one processor are further configured to:
receive a sidelink transmission from the one or more UEs at a reception time with a sidelink reception frame timing that is offset from the reference time based at least on the initial timing advance.

6. The apparatus of claim 5, wherein the memory and the at least one processor are further configured to:
adjust the transmission time or the reception time based at least on a timing advance update for the sidelink communication with the one or more UEs, the timing advance update being based on a propagation delay between the aerial device and the one or more UEs.

7. The apparatus of claim 6, wherein the memory and the at least one processor are further configured to:
transmit or receive a higher priority channel in response to an overlap in time between a physical sidelink shared channel (PSSCH) and a physical sidelink feedback channel (PSFCH).

8. The apparatus of claim 7, wherein a channel priority is based on sidelink control information (SCI) scheduling the PSSCH or the PSFCH.

9. The apparatus of claim 7, wherein a priority of the PSFCH is based on a corresponding PSSCH.

10. The apparatus of claim 7, wherein the memory and the at least one processor are further configured to:
skip transmission or reception of a lower priority channel between the PSSCH and the PSFCH.

11. The apparatus of claim 6, wherein the memory and the at least one processor are further configured to:
monitor for a physical sidelink control channel (PSCCH) and skip transmission of a physical sidelink feedback channel (PSFCH) that overlaps in time with the PSCCH.

12. The apparatus of claim 1, further comprising:
at least one antenna coupled to the at least one processor.

13. An apparatus for wireless communication at a base station, comprising:
memory; and
at least one processor coupled to the memory, the memory and the at least one processor configured to:
transmit downlink communication for one or more user equipment (UEs) to an aerial device for relay over a sidelink; and
transmit, to the aerial device, an indication of a timing advance configuration for sidelink communication with the one or more UEs, the timing advance configuration indicating an initial timing advance for the sidelink communication.

14. The apparatus of claim 13, wherein the initial timing advance is based on a current altitude of the aerial device.

15. The apparatus of claim 13, further comprising:
at least one antenna coupled to the at least one processor.

16. An apparatus for wireless communication at a user equipment (UE), comprising:
memory; and
at least one processor coupled to the memory, the memory and the at least one processor configured to:
transmit sidelink transmissions to multiple aerial devices based on a common frame timing; and
receive relayed transmissions from the multiple aerial devices based on the common frame timing.

17. The apparatus of claim 16, wherein the sidelink transmissions to the multiple aerial devices overlap at least partially in time.

18. The apparatus of claim 16, wherein the common frame timing is based on a reference time without a timing advance for individual aerial devices.

19. The apparatus of claim 16, further comprising:
at least one antenna coupled to the at least one processor.

20. A method of wireless communication at an aerial device, comprising:
receiving a timing advance configuration from a base station for sidelink communication with one or more user equipments (UEs), the timing advance configuration indicating an initial timing advance for the sidelink communication; and
transmitting a discovery message from the aerial device to the one or more UEs at a transmission time based on the initial timing advance with reference to a reference time of a sidelink synchronization reference.

21. The method of claim 20, wherein the timing advance configuration for the aerial device comprises a set of timing advance values each associated with a different altitude value.

22. The method of claim 20, wherein a value of the initial timing advance is based on a current altitude of the aerial device.

23. The method of claim 20, wherein the reference time of the sidelink synchronization reference is a time of the base station, the transmitting the discovery message from the aerial device to the one or more UEs further includes:
transmitting the discovery message to the one or more UEs at the transmission time based on the initial timing advance and an uplink timing advance for communication with the base station.

24. The method of claim 20, further comprising:
receiving a sidelink transmission from the one or more UEs at a reception time with a sidelink reception frame timing that is offset from the reference time based at least on the initial timing advance.

25. The method of claim 24, further comprising:
adjusting the transmission time or the reception time based at least on a timing advance update for the sidelink communication, the timing advance update being based on a propagation delay between the aerial device and the one or more UEs.

26. The method of claim 25, further comprising:
transmitting or receiving a higher priority channel in response to an overlap in time between a physical sidelink shared channel (PSSCH) and a physical sidelink feedback channel (PSFCH).

27. The method of claim 26, wherein a channel priority is based on sidelink control information (SCI) scheduling the PSSCH or the PSFCH.

28. The method of claim 26, wherein a priority of the PSFCH is based on a corresponding PSSCH.

29. The method of claim 26, further comprising:
skipping transmission or reception of a lower priority channel between the PSSCH and the PSFCH.

30. The method of claim 25, further comprising:
monitoring for a physical sidelink control channel (PSCCH) and skipping transmission of a physical sidelink feedback channel (PSFCH) that overlaps in time with the PSCCH.
